(19) United States
(12) Patent Application Publication
(10) Pub. No.: US 2014/0337773 A1
(43) Pub. Date: Nov. 13, 2014

(54) DISPLAY APPARATUS AND DISPLAY METHOD FOR DISPLAYING A POLYHEDRAL GRAPHICAL USER INTERFACE

(71) Applicant: SAMSUNG ELECTRONICS CO., LTD., Suwon-si (KR)

(72) Inventors: Joon-ho PHANG, Seoul (KR); Joo-sun MOON, Seoul (KR); Christopher E. BANGLE, Clavesana CN (IT)

(73) Assignee: SAMSUNG ELECTRONICS CO., LTD., Suwon-si (KR)

(21) Appl. No.: 14/274,284

(22) Filed: May 9, 2014

(30) Foreign Application Priority Data
May 10, 2013 (KR) 10-2013-0053426

(51) Int. Cl. G06F 3/0481; G06F 3/0484

(52) U.S. Cl. CPC G06F 3/0481; G06F 3/0484
USPC 715/767

(57) ABSTRACT

A display apparatus for displaying content-related information as a polyhedral graphical user interface (GUI) is provided. The display apparatus includes a display configured to display a plurality of polyhedral GUIs on a screen, and a controller configured to control the display to display at least one of a size of the plurality of polyhedral GUIs and an arrangement of the plurality of polyhedral GUIs differently depending on a priority of the content-related information.

### CROSS-REFERENCE TO RELATED APPLICATIONS

This application claims priority from Korean Patent Application No. 10-2013-0053426, filed on May 10, 2013, in the Korean Intellectual Property Office, the disclosure of which is incorporated herein by reference in its entirety.

### BACKGROUND

1. Field

Apparatuses and methods consistent with the exemplary embodiments relate to a display apparatus and a user interface (UI) screen providing method thereof, and more particularly, to a display apparatus which displays a polyhedral graphical user interface (GUI), and a UI screen providing method thereof.

2. Description of the Related Art

With the development of electronic technology, various types of display apparatuses have been developed. In particular, display apparatuses such as televisions (TVs), personal computers (PCs), tablet PCs, portable phones, and MPEG audio layer-3 (MP3) players have been distributed so widely that they are now used in most homes.

In recent years, to meet the needs of users who want newer and various functions, attempts to develop new types of display apparatuses have been made. For example, various types of interfaces configured to the display apparatuses have been suggested.

In this regard, there is a need for a method for providing an interface screen which intuitively provides a variety of information and has convenient user operability.

### SUMMARY

The exemplary embodiments are not required to overcome the disadvantages described above, and the exemplary embodiments may not overcome any of the problems described above.

The exemplary embodiments provide a display apparatus which provides a polyhedral GUI with optimization to a user, and a UI screen providing method thereof.

According to an aspect of the exemplary embodiments, a display apparatus for displaying content-related information as a polyhedral graphical user interface (GUI) includes a display configured to display a plurality of polyhedral GUIs on a screen, and a controller configured to control the display to display at least one of a size of the plurality of polyhedral GUIs and an arrangement of the plurality of polyhedral GUIs differently depending on a priority of the content-related information.

The controller may set the priority of the content-related information based on at least one of a user behavior pattern and a content attribute.

The user behavior pattern may include at least one of a past usage behavior of a user, a current usage behavior of a user, and an expected usage behavior of a user. In addition, the arrangement of the GUIs may include at least one of a position of the GUIs on X-Y axes on the screen and a depth of the GUIs on a Z axis on the screen.

The controller may control to display a pointing GUI for navigating a plurality of GUIs on a GUI which represents content-related information having a highest priority.

When a plurality of content-related information are associated with each other, the controller may control to display a plurality of GUIs which represent the plurality of content-related information respectively in proximity to each other.

The controller may control to array and display a plurality of panel GUIs in a form where a GUI among the plurality of GUIs is sliced on a Y axis on the screen according to a predetermined event.

The plurality of panel GUIs may include at least one of detailed information, associated information, and recommended information of a content-related information which is displayed by the GUIs.

The controller may control the plurality of panel GUIs to be arrayed sequentially according to at least one of a generation time of sub information which is displayed by each of the plurality of panel GUIs, an update time of the sub information, and an association degree between the content-related information and the sub information.

The controller may control to display the plurality of GUIs as floating in a three-dimensional space which is formed by a plurality of walls being arrayed along the X axis and having a predetermined depth along the Z axis on the screen.

The display apparatus may further include a user interface configured to receive a user interaction. In addition, the controller may control to convert and display a GUI list which is currently displayed in the three-dimensional space into a previous or a next list according to the user interaction.

When the user interaction is inputted while a pointing device is displayed on a GUI which is displayed on a predetermined position on the screen, the controller may control to convert and display a list according to a list conversion direction which is mapped on the predetermined position.

The controller may control at least one GUI included in a previous or a next list to be displayed with a predetermined transparency on at least one of the plurality of walls.

The content-related information may include at least one of multimedia content information, content provider information, and service provider information.

According to another aspect of the exemplary embodiments, a method of providing a user interface (UI) screen of a display apparatus configured to display content-related information as a polyhedral GUI includes setting a priority of content-related information displayed by a plurality of polyhedral GUIs, and displaying at least one of a size of the plurality of polyhedral GUIs and an arrangement of the plurality of polyhedral GUIs differently based on the priority.

The setting a priority may include setting a priority of the content-related information based on at least one of the user behavior pattern and the content attribute.

The user behavior pattern may include at least one of the past usage behavior of a user, the current usage behavior of a user, and the expected usage behavior of a user. In addition, the arrangement of the GUIs may include at least one of the position of the GUIs on the X-Y axes on the screen and the depth of the GUIs on the Z axis on the screen.

The displaying may include displaying the pointing GUI for navigating a plurality of GUIs on a GUI which represents content-related information having the highest priority.

When a plurality of content-related information are associated with each other, the displaying may include displaying a plurality of polyhedral GUIs which represent the plurality of content-related information respectively in proximity to each other.

The method may further include displaying a plurality of panel GUIs in the form where a GUI among the plurality of GUIs is sliced on the Y axis on the screen according to the predetermined event. In addition, the plurality of panel GUIs may include at least one of detailed information, associated information, and recommended information of the content-related information which is displayed by the GUIs.

The displaying the plurality of panel GUIs may include displaying the plurality of panel GUIs to be arrayed sequentially according to at least one of the generation time of sub information which is displayed by each of the plurality of panel GUIs, the update time of the sub information, and the association degree between the content-related information and the sub information.

According to the above-described various exemplary embodiments, an optimized screen may be provided to a user to improve convenience of the user.

Additional and/or other aspects of the exemplary embodiments will be set forth in part in the description which follows and, in part, will be obvious from the description, or may be learned by practice of the exemplary embodiments.

### BRIEF DESCRIPTION OF THE DRAWING FIGURES

The above and/or other aspects of the exemplary embodiments will be more apparent by describing certain exemplary embodiments with reference to the accompanying drawings, in which:

FIG. 1 is a view explaining a display system according to an exemplary embodiment;

FIGS. 2A and 2B are block diagrams illustrating configurations of display apparatuses according to an exemplary embodiment;

FIG. 3 is a view explaining various software modules stored in a storage according to an exemplary embodiment;

FIGS. 4A to 18 are views illustrating UI screens according to various exemplary embodiments;

FIG. 19 is a view explaining a UI screen providing method according to an exemplary embodiment;

FIG. 20 is a view explaining a UI screen providing method according to another exemplary embodiment;

FIG. 21 is a view explaining a UI screen providing method according to another exemplary embodiment;

FIG. 22 is a view explaining a UI screen providing method according to another exemplary embodiment; and

FIG. 23 is a view explaining a UI screen providing method according to another exemplary embodiment.

### DETAILED DESCRIPTION OF EXEMPLARY EMBODIMENTS

Certain exemplary embodiments will now be described in greater detail with reference to the accompanying drawings.

In the following description, the same reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

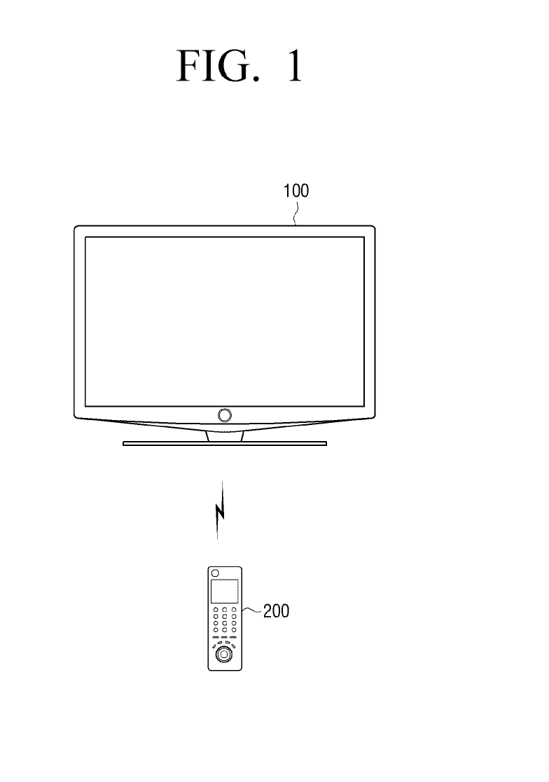

FIG. 1 is view explaining a display system according to an exemplary embodiment.

Referring to FIG. 1, the display system according to an exemplary embodiment includes a display apparatus 100 and a remote control apparatus 200.

The display apparatus 100 may be implemented as a digital TV as illustrated in FIG. 1, but the display apparatus 100 is not limited thereto. The display apparatus may be implemented as various types of apparatuses having a display function, such as a PC, a portable phone, a tablet PC, a laptop computer, an electronic photo frame, a kiosk, a portable multimedia player (PMP), a personal digital assistant (PDA), or a navigation system. When the display apparatus 100 is implemented as a portable apparatus, the display apparatus 100 may be implemented with a touch screen embedded therein to execute a program using a finger or a pen (for example, a stylus pen). Hereinafter, for convenience of description, it is assumed and described that the display apparatus 100 is implemented as the digital TV.

When the display apparatus 100 is implemented as the digital TV, the display apparatus 100 may be controlled by a user motion or the remote control apparatus 200. The remote control apparatus 200 may be an apparatus configured to remotely control the display apparatus 100, and may receive a user command, and transmit a control signal corresponding to the input user command to the display apparatus 100. For example, the remote control apparatus 200 may be implemented in various types, for example, to sense a motion of the remote control apparatus 200 and transmit a signal corresponding to the motion, to recognize a voice and transmit a signal corresponding to the recognized voice, or to transmit a signal corresponding to an input key. At this time, the remote control apparatus 200 may be implemented to include a motion sensor, a touch sensor, or an optical joystick (OJ) sensor applying optical technology, a physical button (for example, a tact switch), a display screen, a microphone, and the like configured to receive various types of user commands. Here, the OJ sensor is an image sensor configured to sense a user operation through an OJ, and operates like an upside-down optical mouse. That is, the user may simply touch the OJ with a finger, and the OJ will analyze a signal corresponding to the touch.

The display apparatus 100 may provide various UI screens according to the user command input through the remote control apparatus 200.

In particular, the display apparatus 100 may provide a UI screen for user interfacing, and the UI screen may include a polyhedral GUI element. Hereinafter, various exemplary embodiments will be described with reference to a block diagram illustrating a specific configuration of the display apparatus 100.

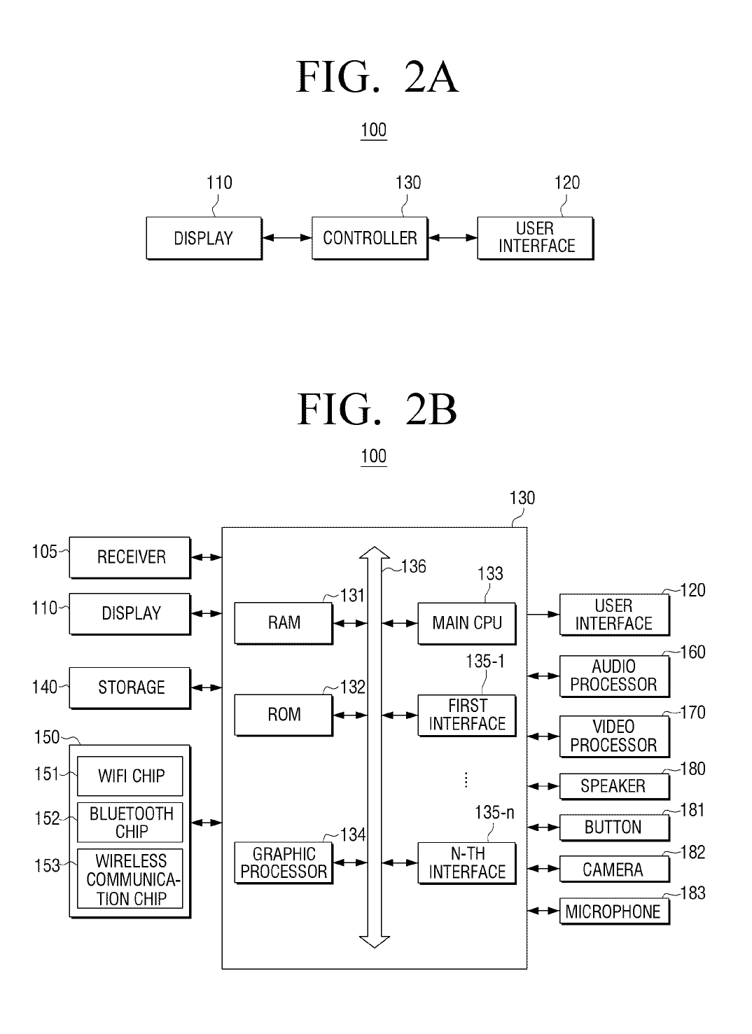

FIGS. 2A and 2B are block diagrams illustrating configurations of a display apparatus according to an exemplary embodiment.

Referring to FIG. 2A, a display apparatus 100 includes a display 110, a user interface 120, and a controller 130.

The display displays a screen which may include a reproduction screen of a variety of content such as an image, a moving image, text, and music, an application execution screen including a variety of content, a web browser screen, a GUI screen, or the like.

The display 110 may be implemented as a liquid crystal display (LCD), an organic light emitting diode (OLED), and the like, but the display 110 is not limited thereto. In some cases, the display 110 may be implemented as a flexible display, a transparent display, and the like.

The display 110 may display a polyhedral GUI according to a preset event according to an exemplary embodiment. The polyhedron may be a cube, and the polyhedral GUI may be referred to as a cubic GUI. However, the polyhedron is not limited to a cubic shape. The polyhedron may be implemented in various shapes, such as a triangular prism, a hexagonal prism, or a rectangular parallelepiped. Hereinafter, it is assumed and described that the polyhedral GUI is a cubic GUI.

<Shape of and Information Provided by Cubic GUI>

The cubic GUI is a polyhedral display element, and the cubic GUI may be implemented to represent predetermined content-related information. For example, the cubic GUI may represent a variety of content-related information, such as content, a content provider, and a service provider.

At least one surface constituting the cubic GUI may function as an information surface for providing predetermined information to a user. That is, the at least one surface constituting the cubic GUI may provide a variety of information according to the content-related information represented by the cubic GUI. For example, the at least one surface constituting the cubic GUI may display a variety of information, such as content provider information, content information, service provider information, service information, application execution information, content execution information, and user information, depending on a menu depth according to a user command. Further, displayed information may include various elements, such as text, a file, an image, a moving image, an icon, a button, a menu, and a three dimensional (3D) icon. For example, the content provider information may be provided in a type of an icon, a logo, or the like which symbolizes a corresponding content provider, and the content information may be provided in a thumbnail form. The user information may be provided in a profile image of each user. The thumbnail may be provided by decoding additional information provided in original content, and converting the decoded additional information into a thumbnail size, or by decoding the original content, converting the decoded original content in the thumbnail size, and extracting a reduced thumbnail image when there is no additional information. Here, the original content may be a still image form or a moving image form. When the original content is a moving image, a thumbnail image may be generated in the form of an animated image configured of a plurality of still images.

In some cases, the at least one surface constituting the cubic GUI may be implemented to perform a predetermined function. For example, when the cubic GUI is displayed in a state in which a specific surface constituting the cubic GUI is exposed, a function such as screen mode conversion is directly performed.

<Display Space of the Cubic GUI>

The display 110 may display a UT screen in a form in which a cubic GUI is floating in a three-dimensional (3D) space.

Specifically, the display 110 may display the UI screen in a form in which the cubic GUIs are floating at different X-Y coordinates in a 3D space formed by three walls arranged along an x-axis on the screen and having a preset depth along a Z-axis. That is, the display 110 may display the UI screen in a form in which a plurality of cubic GUIs are floating at the different X-Y coordinates to expose front surfaces thereof in the space, that is, the 3D space, which is a room-shaped space in which a first wall of the three walls forms a left surface, a second wall forms a rear surface, and a third wall forms a right surface. Here, the floating form is a form in which the cubic GUI appears to be floating in the 3D space, and may provide the user with a feeling as if the plurality of cubic GUIs are spaced from each other and move fluidly.

The 3D space (hereinafter referred to as a cubic room) including a cubic GUI may be implemented such that a plurality of cubic rooms are provided, and a new cubic room is displayed according to rotation. Specifically, an aisle area disposed in a center of the GUI, and regular hexahedral cubic rooms disposed to be connected to each other through the aisle area, and to be spaced in a form of surrounding the aisle area, may be presented. That is, an overall shape of the cubic rooms may be implemented to have a star-like structure. The cubic rooms may represent different categories, and content-related information included in each of the categories may be displayed through cubic GUIs. Here, the categories may be divided into various types, for example, a real time TV watching category, a video on demand (VOD) content-based category, a social networking service (SNS) content sharing-based category, an application providing category, a personal content category, and the like. The division of the categories is merely exemplary, and the categories may be divided according to various criteria.

The cubic room may further include a ceiling space and a floor space, and a variety of information and functions may be provided in the spaces. For example, additional information such as weather information or stock information may be provided in the ceiling space, and a home control system may be provided in the floor space. The ceiling and floor spaces may be implemented to provide corresponding information when the ceiling and floor spaces are displayed as a main space according to a head up/down interaction or a pointing interaction of the remote control apparatus 200.

<Display Arrangement Type of the Cubic GUI>

The display 110 may display a plurality of cubic GUIs arranged in an n*m matrix form, and separated from each other by a constant distance. However, this arrangement of the plurality of cubic GUIs is merely exemplary, and the plurality of cubic GUIs may have various types of arrangements such as a radial arrangement or a linear arrangement.

<Method of Providing the Cubic GUI>

The display 110 may provide cubic GUIs in a two-dimensional (2D) or 3D manner. Here, the 2D method may be a display method for displaying the cubic GUIs in a form in which only one surface of each of the cubic GUIs is displayed and other surfaces thereof are hidden. The 3D method may be a method for displaying the cubic GUIs in a 3D form in which at least two surfaces each of the cubic GUIs are displayed.

<Method of Providing the UI Screen>

The display 110 may provide a UI screen including cubic GUIs in a 2D screen type or a 3D screen type. That is, the display 110 may implement a 3D screen by time-dividing a left-eye image and a right-eye image, and alternately displaying the time-divided left-eye image and right-eye image. Therefore, the user may obtain depth information of a 3D object such as the cubic GUI, and feel a cubic effect.

<Other Exemplary Embodiments of Cubic GUI>

The display 110 may provide an openable and closable cubic GUI. For example, the cubic GUI may be configured to allow at least one surface constituting the cubic GUI to be opened and closed, and provide different information according to opening and closing speeds and opening and closing manners of the opened and closed surface. Further, both sides of the opened and closed surface may be used as information surfaces after the closed surface is opened.

Further, the display may provide a detachable or combinable cubic GUI.

Specifically, one cubic GUI may be divided to provide a plurality of different pieces of information, or a plurality of cubic GUIs may be combined to represent one piece of new information. For example, when a cubic GUI representing a content provider is divided into a plurality of sub cubic GUIs, the sub cubic GUIs may represent different information provided from the content provider. Alternatively, when a cubic GUI representing content is divided into a plurality of sub cubic GUIs, the sub cubic GUIs may represent different series content of the content, or thumbnails of the content. Alternatively, when a plurality of cubic GUIs representing different content are combined to one cubic GUI, the one combined cubic GUI may represent upper content including the different content.

<Provision of a Plurality of Screens>

The display 110 may provide a screen in which a plurality of screens are displayed. For example, when a plurality of pieces of content mapped to the plurality of cubic GUIs or a plurality of pieces of content mapped to one cubic GUI are selected, the plurality of pieces of selected content may be displayed on the plurality of screens. At this time, in the former case, the plurality of pieces of content may be selected through selection of the plurality of cubic GUIs, and in the latter case, the plurality of pieces of content may be selected through selection of the one cubic GUI. In some cases, other related cubic GUIs may be automatically selected through the selection of the one cubic GUI, and reproduced on the plurality of screens.

The plurality of screens may be displayed in a form including a main screen disposed in a central region of the screen, and first and second sub screens disposed on the left and right of the main screen.

The user interface 120 may receive various user interactions. The user interface 120 may be implemented in various types according to an implementation example of the display apparatus 100. When the display apparatus 100 is implemented with a digital TV, the user interface 120 may be implemented with a remote controller receiver configured to receive a remote controller signal from the remote control apparatus 200, a camera configured to sense a motion of the user, a microphone configured to receive a voice of the user, and the like. Further, when the display apparatus 100 is implemented with a touch-based portable terminal, the user interface 120 may be implemented in a touch screen form forming a mutual layer structure with a touch pad. At this time, the user interface unit 120 may be used as the above-described display 110.

<User Interaction for the Cubic GUI>

The user interface 120 may receive various user interactions for a cubic GUI. Specifically, the user interface 120 may receive various user commands, such as a user interaction for selecting a cubic GUI, a user interaction for rotating the cubic GUI, a user interaction for changing a display angle of a cubic GUI, and a user interaction for slicing the cubic GUI. For example, the user interface 120 may sense at least one of head rotation and head movement of the user through a camera, and transmit the sensed signal to the controller 130 to be described later to allow the cubic GUI to be rotated and displayed.

<User Interaction for Cubic GUI List Conversion>

The user interface 120 may receive a user interaction for cubic GUI list conversion provided in a displayed specific cubic room.

Specifically, the cubic GUI list may be converted and displayed according to a user interaction for a cubic GUI disposed in a specific location among a plurality of cubic GUIs. For example, when the plurality of cubic GUIs are arranged in a 3*3 matrix form, the cubic GUI list is converted into a next cubic list when there is a preset event for at least one cubic GUI among cubic GUIs disposed on bottom and left sides, and the cubic GUI list is converted into a previous cubic list when a preset event for at least one cubic GUI among cubic GUIs disposed on top and right sides. Here, the cubic list may be a list disposed on the basis of a Z-axis of a screen. For example, GUI pages corresponding to the cubic lists may be arranged on the basis of a virtual Z-axis. That is, a GUI page corresponding to the previous list is disposed in a virtual location having a depth of a +Z-axis direction rather than a currently displayed GUI page, and a GUI page corresponding to the next list is disposed in a virtual location having a depth of a −Z-axis direction rather than the currently displayed GUI page.

In some cases, as described above, the user interaction for the cubic GUI list conversion may overlap the user interaction for the cubic GUI.

<User Interaction for Arrangement Space of the Cubic GUIs>

The user interface 120 may receive various user interactions for a 3D space in which cubic GUIs are displayed, that is, a cubic room. Specifically, the user interface 120 may receive various user commands, such as a user interaction for converting a display angle of a cubic room, a user interaction for converting a displayed cubic room into another cubic room, and a user interaction for converting a main display space (for example, a ceiling, a wall, or a floor) of the cubic room. For example, the user interface 120 may sense at least one of head rotation and head movement of the user through a camera, and transmit the sensed signal to the controller to be described later to allow the display angle of the displayed cubic room to be changed and to allow the cubic room to be displayed. Therefore, the cubic room may be displayed by changing a display angle of a plurality of cubic GUIs therein. In another example, the user interface 120 may display the cubic room by rotating a roulette wheel-like space, and converting a first cubic room corresponding to a VOD content-based category displayed on a current screen into a second cubic room corresponding to a network security (NS) content sharing-based category according to a remote control signal received from the remote control apparatus 200.

The controller 130 may function to control an overall operation of the display apparatus 100.

<Various Exemplary Embodiments for the Size and Arrangement State of the Cubic GUIs>

The controller 130 may control the display 110 to set a priority for content-related information representing a plurality of cubic GUIs, and display at least one of a size and an arrangement state of the plurality of cubic GUIs differently according to the set priority. In some cases, at least one of a color transparency, resolution, and a contrast ratio of the cubic GUIs may be displayed differently.

In particular, the controller 130 may set the priority for the content-related information based on at least one of a user behavior pattern and a content attribute.

Here, the content-related information commonly refers to various concepts or objects to be represented by the cubic GUIs in a UI screen, and may refer to at least one among multimedia content information, content provider information, and service provider information. However, the content-related information is not limited thereto. For example, in some cases, the cubic GUI may represent a first user, information for another user, and the like according to a displayed UI screen type. Further, the user behavior pattern may be defined to include all content-related usage history, a use state, and a use environment. Specifically, the user behavior pattern may be defined to include past usage behavior of a user, current usage behavior of the user, and expected usage behavior of the user with respect to the content. For example, when the content-related information represents a broadcasting channel, current selection behavior as well as past selection behavior with respect to the broadcasting channel may correspond to the user's behavior pattern. Here, the user may be defined to include another user or a service provider as well as a user of the display apparatus 100. For example, when the content-related information represents specific content uploaded to an SNS, the user may include other users who comment on the content. In some cases, the priority for the content-related information may be determined according to various surrounding contexts, such as the elapse of time, a location (for example, region) of the display apparatus 100, and ambient lighting. For example, when the user resides in a certain district, the high priority may be set to a broadcasting channel provided in the district.

The user behavior pattern may be analyzed with respect to only a specific user according to a user certification process. For example, the UI according to an exemplary embodiment may be implemented to provide a plurality of users with different UI screens through the certification of the user. That is, since even family members may have different behavior patterns, preferences, and the like from one another, a UI screen corresponding to a behavior pattern of a corresponding user may be provided after a certificate process such as login is performed.

Further, the content attribute may be defined to include all features for discriminating content according to an implementation example of content. For example, the content attribute of multimedia content may be various features of content itself, which are discriminable from other content, such as subject matter of content, a content generation time, an update time, a broadcasting time, a reproduction time, a performer, and the like generated in a generation, distribution, and consumption process of the content. A content attribute of a service provider, for example, an SNS providing server, may be a kind of available service (for example, photo update service), membership, and the like. Further, a content attribute of a broadcasting channel may be a kind and subject matter of the provided content, a channel rating, and the like.

Although a criterion for determining the size and arrangement state of the cubic GUIs is preset in this case, it may be determined in real time. For example, in content such as a broadcast, a photo, music, a movie, or a TV show, the size and arrangement state may be determined based on the user's behavior pattern. In SNS and education-related content, the criterion may be preset to determine the size and arrangement based on the content attribute. In some cases, the criterion may be set according to the user's selection, or determined in the display apparatus 100 in real time.

The size of the cubic GUI may be a size of at least one of six surfaces. Therefore, a different size of the cubic GUI may mean that a size of the at least one surface, that is, one of a horizontal length and a vertical length, is different from those of the other surfaces. For example, a case in which a size of a surface viewed by the user in the front of the cubic is different may also correspond to the case in which the size of the cubic GUI is different. Further, a case in which a size of a side surface obliquely viewed by the user is different may also correspond to the case in which the size of the cubic GUI is different.

Further, the arrangement state of the cubic GUIs may include at least one of a location of the cubic GUI on X-Y axes of a screen, and a depth of the cubic GUI on an X-axis of the screen. A difference in the arrangement states of the cubic GUIs may be a difference in location coordinates of the cubic GUIs on the X-Y axes of the screen or a difference in location coordinates of the cubic GUIs on the Z-axis of the screen. Here, depth is a sense of depth corresponding to a location in a back and forth direction which is a gaze direction of a viewer. The depth in the 3D image may be expressed by a disparity between a left-eye image and a right-eye image, while the depth in the 2D image may be expressed through perspective processing for the cubic GUIs.

For example, even when locations of two cubic GUIs on the X-Y axis of the screen are the same, the arrangement states may be different when depths on the Z-axis are different. The depth on the Z-axis may be changed to +Z-axis direction or −Z-axis direction. Here, the change of the depth to the +Z-axis direction may be expressed as a reduction of the depth, and the change of the depth to the −Z-axis direction may be expressed as an increase of the depth. That is, the expression that the depth is reduced, or the depth is small, means that the cubic GUI is displayed closer to the user, while the expression that the depth is increased, or the depth is large, means that the cubic GUI is displayed farther from the user.

<Various Exemplary Embodiments of Priority Setting>

Specifically, the controller 130 may set a priority for content-related information according to one preset criterion among a plurality of criteria for setting the priority for the content-related information. For example, when an update time is preset as the criterion for setting the priority according to a user command, the priority for all types of content-related information may be set on the basis of the update time.

Further, the controller 130 may set the priority for the content-related information by applying at least one criterion that differs according to the types of the content-related information. For example, when the plurality of cubic GUIs to be displayed on a screen represent broadcasting channels, the controller 130 may set the priority for the broadcasting channels according to a degree of a bookmark, which is a user behavior pattern for the broadcasting channels, and control to display a cubic GUI representing a broadcasting channel having the highest priority in a central portion of the screen and a cubic GUI representing a broadcasting channel having the lowest priority in a bottom right region of the screen, according to the set priority. Alternatively, when the plurality of cubic GUIs to be displayed on a screen represent movie content, the controller 130 may control to display a cubic GUI representing the latest updated movie content to be the smallest depth, and to be closer to the user, and to display a cubic GUI representing the first updated movie content to be the largest depth, to be farthest from the user.

When a plurality of cubic GUIs corresponding to different types of content-related information are displayed, a priority for the different types of content-related information may be collectively set based on a weight pre-assigned to at least one criterion preset for the content-related information. For example, it is set that first and second cubic GUIs represent broadcasting channels, third and fourth cubic GUIs represent movie content, a user preference is a criterion for setting the priority of the broadcasting channels, and an update time is a criterion for setting the priority of the movie content. When a higher weight is set to the user preference than to the update time, the priority for the first to fourth cubic GUIs may be set by reflecting corresponding weights. The setting of the priority is merely exemplary, and in some cases, the priority may be set by applying a preset weight to the types of content-related information. For example, a higher weight may be applied to content provider information than to content information and reflected in the setting of the priority.

In some cases, a type of content-related information represented by a first displayed cubic GUI may be used as the criterion for the setting of the priority. For example, when the first displayed cubic GUI represents a content provider, and then a cubic GUI representing content information is mixed on a screen according to user interaction and then displayed, the first displayed content provider may be used as the criterion for the setting of the priority.

The controller 130 may set the priority by integrating a plurality of criteria applicable to the types of content-related information. For example, when a plurality of cubic GUIs to be displayed on a screen represent broadcasting channels, the controller 130 may set the priority by integrating a degree of a bookmark, which is a user's behavior pattern for the broadcasting channels, and a preference of the user for a currently broadcast television program, and control to display a cubic GUI representing a broadcasting channel having the highest priority in a central portion of the screen and a cubic GUI representing a broadcasting channel having the lowest priority in a bottom right region of the screen, according to the set priority.

At this time, the controller 130 may set the priority by assigning different weights to a plurality of available obtainable criteria applicable to the content-related information. For example, in the above-described example, the controller 130 may calculate the integrated priority by assigning a weight of 7/10 to a degree of a bookmark, which is a user's behavior pattern for the broadcasting channels, and assigning a weight of 3/10 to a user preference for broadcast programs currently broadcast in the broadcasting channels.

Alternatively, the controller 130 may set different priorities for one piece of content-related information according to a plurality of criteria, match the preset priorities with different display attributes, and display a matching result. For example, in the above-described example, a first priority based on the degree of a bookmark, which is a user's behavior pattern for each broadcasting channel, may be matched to a size of the cubic GUIs, and a second priority based on the user's preference for the broadcasting programs currently broadcast in the broadcasting channels may be matched to an arrangement state of the cubic GUIs. That is, the content in which the first priority is high and the second priority is low may be largely displayed, and may be displayed in an edge of the screen in a form having a high depth.

The controller 130 may change the content-related information displayed in the cubic GUI according to the priority of the content-related information in a state in which a display location of the cubic GUI and a depth and a size at the location of the cubic GUI are preset, but the controller 130 may freely change the location, size, and depth of the cubic GUI representing the content-related information according to the priority of the content-related information. For example, when a priority of a main cubic GUI displayed to have the largest size and the smallest depth in the central portion of the screen is changed, corresponding content-related information may be displayed in another cubic GUI in a state in which the location, depth and size of the main cubic GUI are maintained, but at least one of the size, location, and depth of the main cubic GUI may be changed.

Further, the controller 130 may control to display a size and an arrangement state of a cubic GUI to be different according to a type of content-related information currently represented by the cubic GUI.

For example, the controller 130 allows a plurality of cubic GUIs to represent content information provided by a content provider according to a preset event in a state in which the plurality of cubic GUIs represent content provider information, and allows only one of a size, a location, and a depth of a cubic GUI to be changed according to the priority of the content provider and the priority of the content. For example, the size and location of the cubic GUI may be displayed to correspond to the priority of the content provider, and the depth of the cubic GUI may be displayed to correspond to the priority of the content.

<Pointing GUI>

The controller 130 may control to display a pointing GUI for navigating through a plurality of cubic GUIs to select a cubic GUI representing content having the highest priority. Here, the pointing GUI moves according to a user command to select a specific cubic GUI. The pointing GUI may be a highlighted GUI, but is not limited thereto. For example, the controller 130 may display the pointing GUI as a cubic GUI representing the latest updated movie content in the above-described example.

<Display of Cubic GUI According to Degree of Association>

The controller 130 may determine a degree of association of a plurality of cubic GUIs to be displayed on a screen, determine locations of the cubic GUIs according to a degree of association, and display the cubic GUIs.

Here, various criteria may be applied to determine the degree of association according to types of content-related information represented by the cubic GUIs. For example, when the plurality of cubic GUIs to be displayed on the screen represent movie content, the degree of association may be determined based on similarity of genres, similarity of actors, similarity of release dates, and the like.

The controller 130 may display mutually related content in adjacent locations, or display the content in the same color or contrast ratio or in similar colors or contrast ratios.

<Slicing of Cubic GUI>

The controller 130 may arrange and display a plurality of panel GUIs, into which a cubic GUI is sliced according to a preset event, on a preset axis of the screen. Here, the axis which is a criterion for arrangement of the plurality of panel GUIs may be a Y-axis. However, the axis is not limited thereto, and the panel GUIs may be arranged on the basis of an X-axis or a Z-axis. The preset event may be various events in a state in which a cubic GUI is pointing. For example, the preset event may be implemented in various forms, such as a motion of pointing the remote control apparatus 200 in a direction of a screen in a state in which the cubic GUI is pointing, an operation of pushing a scroll key provided in the remote control apparatus 200 or a touch panel in an upward direction, and a user's motion. At this time, the plurality of panel GUIs may include at least one among detailed information, associated information, and recommended information of content-related information represented by a corresponding cubic GUI. For example, the detailed information of the content-related information may include picture images of a detailed thumbnail information photo folder of a moving image, SNS update information, and the like. The associated information may include a recorded series of a VOD, and the like, and the recommended information may include content similar to currently reproduced content (for example, a movie, music, and the like).

The controller 130 may sequentially array and display a plurality of panel GUIs on a preset axis of a screen according to at least one among a generation time of sub information represented by each of the plurality of panel GUIs, an update time of the sub information, and a degree of association of content represented by the sub information and a cubic GUI. Here, the sub information may be at least one among the detailed information, the association information, and the recommendation information of the content-related information as described above.

For example, when a cubic GUI represents specific broadcast content, a plurality of panel GUIs having a form into which the cubic GUI is sliced may represent a plurality of pieces of sub content corresponding to each turn of the content, and may be sequentially arrayed and displayed on a Y-axis of a screen.

<Cubic GUI List Conversion>

The controller 130 may control to display a cubic GUI in a floating form in a 3D space which is formed by three walls along an X-axis of a screen.

The controller 130 may display a plurality of cubic GUIs included in a first cubic GUI list, that is, a current cubic GUI list, in the 3D space in a floating form, and convert and display the plurality of cubic GUIs into a plurality of cubic GUIs included in a second cubic GUI list, that is, a next cubic GUI list or a previous cubic GUI list, according to a user command received through the user interface 120.

Specifically, the controller 130 may convert and display a cubic GUI list according to a list conversion direction pre-mapped to a preset location when a user command for list conversion is input in a state in which a pointing GUI is displayed in a cubic GUI displayed in the preset location of a screen.

For example, in a state in which the pointing GUI is located in one of five cubic GUIs disposed in lowermost and rightmost locations when nine cubic GUIs are displayed in a 3*3 matrix form in the 3D space displayed on the screen, the controller 130 may control to display cubic GUIs included in the next cubic GUI list when the user command for the cubic GUI list conversion is input. Alternatively, in a state in which the pointing GUI is located in one of five cubic GUIs disposed in uppermost and leftmost locations, the controller 130 may control to display cubic GUIs included in the previous cubic GUI list when the user command for the cubic GUI list conversion is input. However, the cubic GUI list conversion is merely exemplary, and the list conversion direction for display locations of cubic GUIs may be variously matched by a manufacturer or a setting of a user.

The controller 130 may control at least one cubic GUI included in a cubic GUI list to be displayed next to a cubic GUI list currently displayed on a screen to be displayed with a preset transparency in at least one of the three walls. For example, the controller 130 may control cubic GUIs included in next cubic GUI list to be displayed in a form in which the cubic GUIs are transparently displayed on the right wall of the three walls, and control cubic GUIs included in a previous cubic GUI list to be displayed in a form in which the cubic GUIs are transparently displayed on the left wall. Therefore, the user may check in advance that the cubic GUIs displayed on the right wall are displayed according to the list conversion command in a right direction, and the cubic GUIs displayed on the left wall are displayed according to a list conversion command in a left direction. However, the display method is merely exemplary, and various settings such as a manner in which at least one of the three walls is provided to be translucent, and a next cubic GUI list is displayed on the translucent wall are possible.

FIG. 2B is a block diagram illustrating a detailed configuration of a display apparatus 100 according to another exemplary embodiment. Referring to FIG. 2B, the display apparatus 100 includes an image receiver 105, a display 110, a user interface 120, a controller 130, a storage 140, a communication device 150, an audio processor 160, a video processor 170, a speaker 180, a button 181, a camera 182, and a microphone 183. Detailed description for portions of components illustrated in FIG. 2B that are the same the components illustrated in FIG. 2A will be omitted.

The image receiver 105 receives image data through various sources. For example, the image receiver 105 may receive broadcast data from an external broadcasting station, receive image data from an external apparatus (for example, a digital versatile disc (DVD) player, a Blu-ray disc (BD) player, and the like), and receive image data stored in the storage 140. In particular, the image receiver 105 may include a plurality of image reception modules to display a plurality of screens in one display screen. For example, the image receiver 105 may include a plurality of tuners to simultaneously display a plurality of broadcasting channels.

The controller 130 controls an overall operation of the display apparatus 100 using various programs stored in the storage 140.

Specifically, the controller 130 includes a random access memory (RAM) 131, a read only memory (ROM) 132, a main central processing unit (CPU) 133, a graphic processor 134, first to n-th interfaces 135-1 to 135-n, and a bus 136.

The RAM 131, the ROM 132, the main CPU 133, the graphic processor 134, the first to n-th interfaces 135-1 to 135-n, and the like may be electrically coupled to each other through the bus 136.

The first to n-th interfaces 135-1 to 135-n are coupled to the above-described components. One of the interfaces may be a network interface coupled to an external apparatus through a network.

The main CPU 133 accesses the storage 140 to perform booting using an operating system (O/S) stored in the storage 140. The main CPU 133 performs various operations using various programs, content, data, and the like stored in the storage 140.

A command set, and the like for system booting is stored in the ROM 132. When a turn-on command is input to supply power, the main CPU 133 copies the O/S stored in the storage 140 to the RAM 131 according to a command stored in the ROM 132, and executes the O/S to boot a system. When the booting is completed, the main CPU 133 copies various application programs stored in the storage 140 to the RAM 131, and executes the application programs copied to the RAM 131 to perform various operations.

The graphic processor 134 generates a screen including various objects such as an icon, an image, text, and the like using an operation unit (not shown) and a renderer (not shown). The operation unit (not shown) calculates attribute values such as coordinate values, in which the objects are displayed according to a layout of a screen, shapes, sizes, and colors based on a received control command. The renderer (not shown) generates a screen having various layouts including the objects based on the attribute values calculated in the operation unit. The screen generated in the renderer is displayed in a display area of the display 110.

The operation of the above-described controller 130 may be performed by the program stored in the storage 140.

The storage 140 stores a variety of data such as an O/S software module for driving the display apparatus 100, a variety of multimedia content, a variety of applications, and a variety of content input or set during application execution.

In particular, the storage 140 may store data for constituting various UI screens including a cubic GUI provided in the display 110 according to an exemplary embodiment.

Further, the storage 140 may store data for various user interaction types, functions thereof, provided information, and the like.

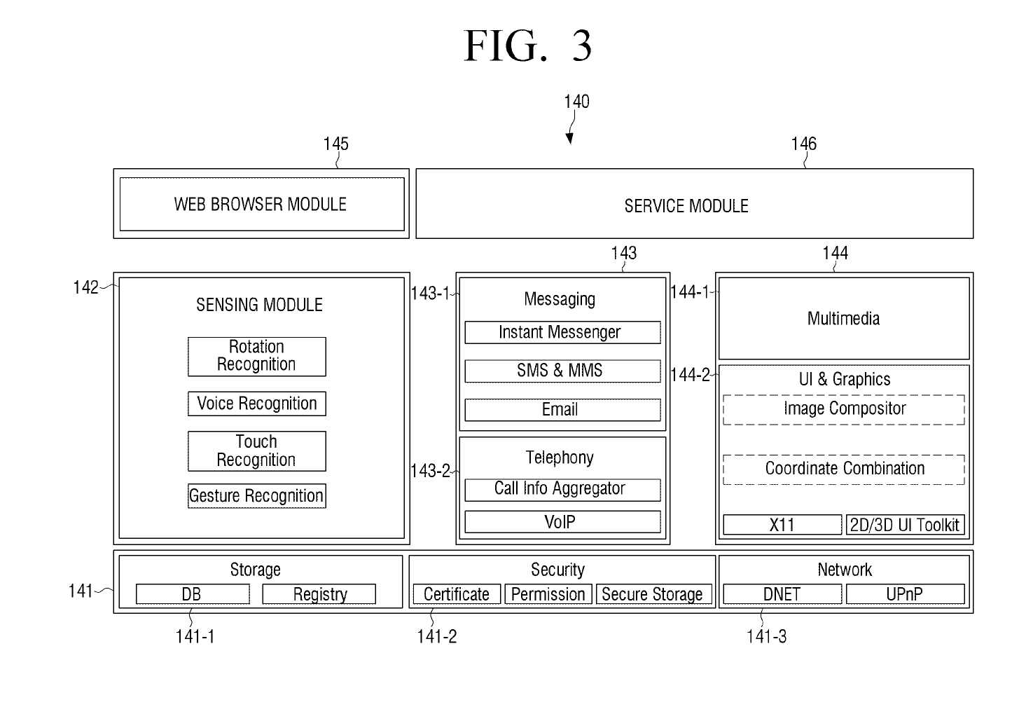

Various software modules stored in the storage 140 will be described with reference to FIG. 3.

Referring to FIG. 3, software including a base module 141, a sensing module 142, a communication module 143, a presentation module 144, a web browser module 145, and a service module 146 may be stored in the storage 140.

The base module 141 is a basic module configured to process signals transmitted from hardware included in the display apparatus 100 and transmit the processed signals to an upper layer module. The base module 141 includes a storage module 141-1, a security module 141-2, a network module 141-3, and the like. The storage module 141-1 is a program module configured to manage a database (DB) or a registry. The main CPU 133 accesses a database in the storage 140 using the storage module 141-1 to read a variety of data. The security module 141-2 is a program module configured to support certification to hardware, permission, secure storage, and the like, and the network module 141-3 is a module configured to support network connection, and may include a device Net (DNET) module, a universal plug and play (UPnP) module, and the like.

The sensing module 142 is a module configured to collect information from various sensors, and analyze and manage the collected information. The sensing module 142 may include a head direction recognition module, a face recognition module, a voice recognition module, a motion recognition module, a near field communication (NFC) recognition module, and the like.

The communication module 143 is a module configured to perform communication with an external source. The communication module 143 may include a messaging module 143-1, such as a messenger program, a short message service (SMS) & multimedia message service (MMS) program, and an E-mail program, a call module 143-2 including a call information aggregator program module, a voice over internet protocol (VoIP) module, and the like.

The presentation module 144 is a module configured to construct a display screen. The presentation module 144 includes a multimedia module 144-1 configured to reproduce and output multimedia content, and a UI rendering module 144-2 configured to perform UI and graphic processing. The multimedia module 144-1 may include a player module, a camcorder module, a sound processing module, and the like. Accordingly, the multimedia module 144-1 operates to reproduce a variety of multimedia content, and to generate a screen and a sound. The UI rendering module 144-2 may include an image compositor module configured to composite images, a coordinate combination module configured to combine and generate coordinates on a screen in which an image is to be displayed, an X11 module configured to receive various events from hardware, and a 2D/3D UI toolkit configured to provide a tool for forming a 2D type or 3D type UI.

The web browser module 145 is a module configured to perform web browsing to access a web server. The web browser module 145 may include various modules, such as a web view module configured to form a web page, a download agent module configured to perform download, a bookmark module, and a web kit module.

The service module 146 is a module including various applications for providing a variety of services. Specifically, the service module 146 may include various program modules, such as an SNS program, a content-reproduction program, a game program, an electronic book program, a calendar program, an alarm management program, and other widgets.

Various program modules have been illustrated in FIG. 3, but the various program modules may be partially omitted, modified, or added according to a kind and characteristic of the display apparatus 100. For example, the storage may be implemented in a form further including a location-based module configured to support location-based services in connection with hardware such as a global positioning system (GPS) chip.

The communication device 150 may perform communication with an external apparatus according to various types of communication methods.

The communication device 150 includes various communication chips such as a wireless fidelity (WIFI) chip 151, a Bluetooth chip 152, or a wireless communication chip 153. The WIFI chip 151 and the Bluetooth chip 152 perform communication in a WIFI manner and a Bluetooth manner, respectively. When the WIFI chip 151 or the Bluetooth chip 152 is used, the communication device 150 may first transmit/receive a variety of connection information such as a service set identifier (SSID) and a session key, connect communication using the information, and transmit/receive a variety of information. The wireless communication chip 153 is a chip configured to perform communication according to various communication standards, such as Institute of Electrical and Electronics Engineers (IEEE), Zigbee, 3rd generation (3G), 3rd Generation Partnership Project (3GPP), or Long Term Evolution (LTE). In addition, the communication device 150 may further include an NFC chip configured to operate in an NFC manner using a band of 13.56 MHz among various radio frequency identification (RF-ID) frequency bands such as 135 kHz, 13.56 MHz, 433 MHz, 860 to 960 MHz, and 2.45 GHz.

In particular, the communication device 150 may perform communication with a server (not shown) configured to provide content or service, or a server (not shown) configured to provide a variety of information, and receive a variety of information for determining a size and an arrangement state of cubic GUIs. For example, the communication device 150 may perform communication with an SNS server (not shown) to receive a plurality of pieces of user information (for example, profile photos, and the like) represented by cubic GUIs in an SNS service providing screen, or to receive associated information between users for determining the size and arrangement state of the cubic GUIs. In another example, the communication device 150 may perform communication with a content providing server (not shown) to receive content information represented by each of the cubic GUIs in a content providing screen, or associated information between pieces of content.

The audio processor 160 is configured to perform processing on audio data. The audio processor 160 may variously perform processing on the audio data, such as decoding, amplification, and noise filtering for the audio data.

The video processor 170 is configured to perform processing on video data. The video processor 170 may variously perform image processing on video data, such as decoding, scaling, noise filtering, frame rate conversion, and resolution conversion for the video data.

The speaker 180 is configured to output various alarm sounds or voice messages as well as a variety of audio data processed in the audio processor 160.

The button 181 may include various types of buttons, such as a mechanical button, a touch pad, or a wheel, which are provided in arbitrary regions of an external appearance of a main body of the display apparatus 100, such as a front side, a lateral side, or a rear side. For example, a button for power-on/off of the display apparatus 100 may be provided.

The camera 182 is configured to capture a still image or a moving image according to control of the user. In particular, the camera 182 may capture various user motions for controlling the display apparatus 100.

The microphone 183 is configured to receive a user's voice or another sound, and convert the received user's voice or the received other sound into audio data. The controller 130 may use the user's voice input through the microphone 183 during a call or may convert the user's voice into audio data, and store the audio data in the storage 140. The camera 182 and the microphone 183 may be a configuration of the above-described user interface 120 according to a function thereof.

When the camera 182 and the microphone 183 are provided, the controller 130 may perform a control operation according to the user's voice input through the microphone 183 or the user's motion recognized by the camera 184. That is, the display apparatus 100 may operate in a motion control mode or a voice control mode. When the display apparatus 100 operates in the motion control mode, the controller 130 activates the camera 182 to image the user, traces a change in motion of the user, and performs a control operation corresponding to the motion change. When the display apparatus 100 operates in the voice control mode, the controller 130 analyzes a user's voice input through the microphone, and operates in the voice recognition mode which performs a control operation according to the analyzed user's voice.

When the display apparatus 100 operates in the motion control mode, the controller 130 may control to change a display state of a cubic room and a cubic GUI according to a direction of the head of the user, and to display the changed cubic room and cubic GUI. Specifically, the controller 130 may rotate and display the cubic room to have an optimum view at a view point of the user according to the direction of the head of the user. For example, when the direction of the user's head is detected to be to the left with respect to a central portion of a screen, the controller 130 may display a currently displayed cubic GUI in a form rotated in a right direction by rotating the currently displayed cubic GUI so that a front side of the currently displayed cubic GUI has an optimum view in the right direction with respect to the central portion of the screen. In some cases, the controller 130 may display the cubic GUI by tracing a direction of the user's face, eyeball movement of the user, and the like to detect a region of the screen where the user is looking, and change and display the display state of the cubic GUI according to the detected region.

The controller 130 identifies an eyeball image from an image of the user imaged by the camera 182 through face modeling technology. The face modeling technology is an analysis process for processing a facial image acquired by an imager and for conversion to digital information for transmission, and one of an active shape modeling (ASM) method and an active appearance modeling (AAM) method may be used. The controller 130 may determine the region at which the user is looking by determining movement of an eyeball using the identified eyeball image, detecting the direction in which the user is looking using the movement of the eyeball, and comparing pre-stored coordinate information of a display screen with the direction in which the user is looking. The method of determining the direction in which the user is looking is merely exemplary, and the region at which the user is looking may be determined using another method. For example, the controller 130 may determine the region at which the user is looking by tracing a face direction of the user.

Alternatively, the controller 130 may control to display the cubic room and the cubic GUI by determining a display perspective according to a gaze direction of the user, and changing a display state of at least one of the cubic room and the cubic GUI to correspond to the determined display perspective. The display perspective means that the cubic room and the cubic GUI are displayed to represent perspective (far and near distance) on a 2D plane like a display as if it were being viewed directly with the eyes. Specifically, the display perspective may be a display method in which displayed objects have perspective at a point of view of the user according to a gaze direction and a location of the user. For example, linear perspective may be applied as a display method. The linear perspective may represent a sense of distance and a composition using a vanishing point, that is, a point at which lines intersect when extension lines of objects are drawn in perspective. One-vanishing-point perspective is called parallel perspective, and has one vanishing point and strong concentration, and may be used in expression of a diagonal composition. Two-vanishing-point perspectives is called oblique perspective, and has two vanishing points which may be located on the left and right of a screen. Three-vanishing-point perspectives is called spatial perspective, and has three vanishing points which may be located on the left and right, and a top or a bottom of a screen. Display forms according to various exemplary embodiments employing the above-described perspectives will be described in detail with reference to drawings.

In addition, the display apparatus may further include various external input ports for connection to various external terminals, such as a headset, a mouse, and a local area network (LAN).

Although not shown in drawings, the display apparatus 100 may further include a feedback providing unit (not shown). The feedback providing unit (not shown) is configured to provide various types of feedback (for example, audio feedback, graphic feedback, haptic feedback, and the like). Specifically, the feedback providing unit may provide feedback corresponding to a case in which a cubic room is converted, a case in which a cubic GUI list is converted, and a size and an arrangement of cubic GUIs are changed, and the like. For example, when a priority of a cubic GUI displayed in a rightmost location of the screen is changed according to a user's behavior pattern, and the cubic GUI is located in a central portion of the screen, the feedback providing unit may provide the graphic feedback and audio feedback for the cubic GUI.

FIG. 2B illustrates an example of a detailed configuration included in the display apparatus, and in some exemplary embodiments, portions of components illustrated in FIG. 2B may be omitted or modified, and other components may be added. For example, when the display apparatus 100 is implemented with a portable phone, the display apparatus may further include a GPS receiver (not shown) configured to receive a GPS signal from a GPS satellite, and calculate a current location of the display apparatus 100, and a digital multimedia broadcasting (DMB) receiver (not shown) configured to receive and process a DMB signal.

Hereinafter, various types of UI screens provided according to various exemplary embodiments will be described with reference to the drawings.

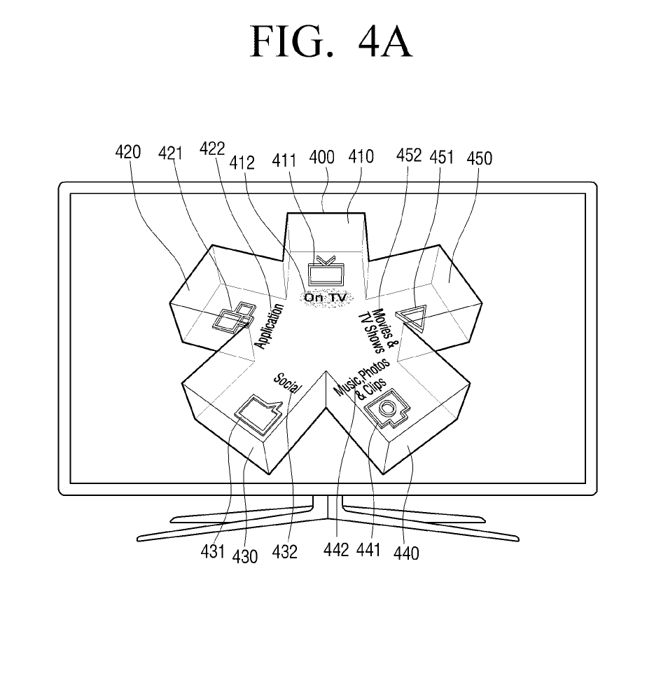

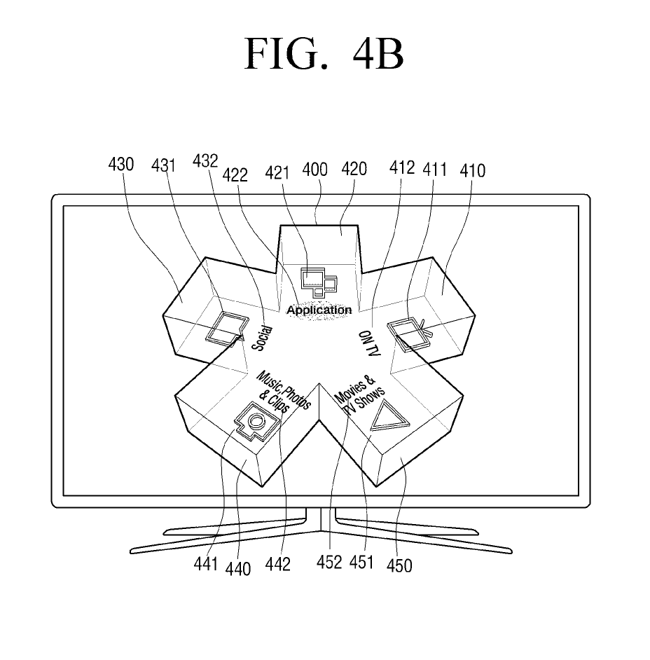

FIGS. 4A and 4B are views illustrating UI screens according to an exemplary embodiment.

Referring to FIG. 4A, a UI screen according to an exemplary embodiment may provide a rotatable GUI 400 including room-shaped 3D spaces 410 to 450, that is, cubic rooms 410 to 450. Specifically, the cubic rooms 410 to 450 may be provided in edges of N-divided spaces having a roulette wheel shape, and the cubic rooms may correspond to different categories of information.

Category information corresponding to each of the cubic rooms may be displayed in a corresponding one of the cubic rooms. Icons 411 to 451 symbolizing categories and simple text information 412 to 452 for the categories may be displayed. As illustrated, the categories may be divided into an “ON TV” category for watching TV in real time, a “Movies & TV shows” for providing VOD content, a “Social” category for sharing SNS content, a “Music, Photos & Clips” for providing personal content, and the like. However, the division of the categories is merely exemplary, and the categories may be divided according to various criteria.

When a specific cubic room is pointed to, the information 412 representing the category of the cubic room is displayed with a highlight to indicate that the cubic room is pointed to or selected.

As illustrated in FIG. 4B, the cubic rooms may rotate according to a user interaction. That is, a cubic room located in a center of the rotatable GUI may be pointed to according to the rotation, the cubic room may be selected according to a preset event to be displayed in an entire screen in a state in which the cubic room is pointed to and selected, and a cubic GUI included in the cubic room may be displayed.

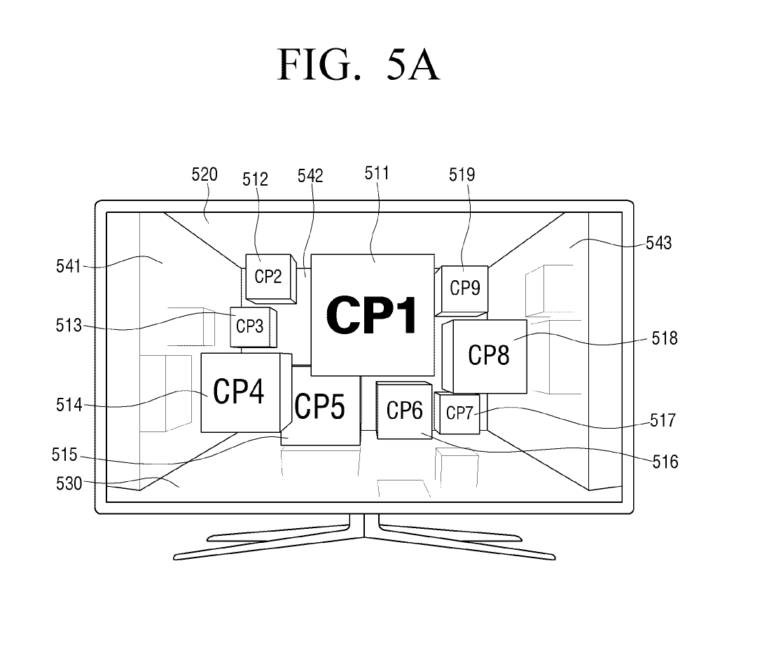

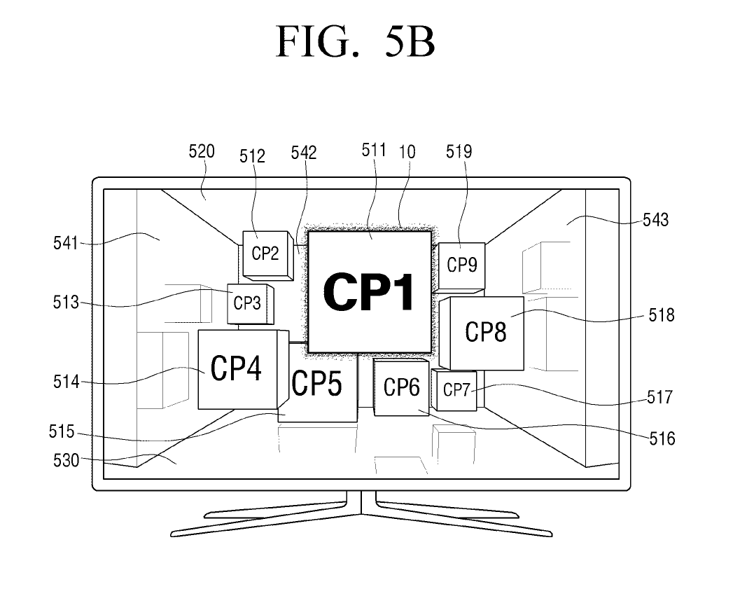

FIGS. 5A and 5B are views illustrating UI screens according to an exemplary embodiment.

FIG. 5A illustrates a case in which a specific cubic room is selected according to a user interaction in the UI screen illustrated in FIGS. 4A and 4B.

When the specific cubic room is selected as illustrated in FIG. 5A, a plurality of cubic GUIs 511 to 519 according to an exemplary embodiment may be displayed to be floating in a 3D space. As illustrated in FIG. 5A, the 3D space may be a space (cubic room) having a room shape formed by three walls 541, 542, and 543 arrayed along an X-axis of a screen, and having preset depths in a Z-axis, a ceiling 520, and a floor 530.

As illustrated in FIG. 5B, the plurality of cubic GUIs 511 to 519 may represent predetermined content-related information received from content providers CP1 to CPn. Specifically, the plurality of cubic GUIs 511 to 519 may represent a variety of content-related information included in a category corresponding to a corresponding cubic room. For example, when the cubic room corresponds to a VOD content-based category, the plurality of cubic GUIs 511 to 519 may represent various content providers who provide VOD content. However, the plurality of cubic GUIs 511 to 519 are merely exemplary, and the plurality of cubic GUIs may represent content (for example, specific VOD content) provided by content providers.

As illustrated in FIG. 5A, the plurality of cubic GUIs 511 to 519 may be displayed in different sizes and arrangement states. The sizes and arrangement states of the cubic GUIs 511 to 519 may be changed according to a priority set according to at least one of a user behavior pattern and a content attribute. Specifically, when content having high priority, for example, a preference of the user, is a criterion, the cubic GUI 511 representing a user's favorite content provider may be displayed in a central portion of a screen to have a smaller depth than other cubic GUIs. That is, the plurality of cubic GUIs 511 to 519 may be displayed to reflect a preference of the user for content-related information, and thus may provide an effect of increasing a recognition rate of the user for the cubic GUI 511. Other cubic GUIs 512 to 519 may also be displayed to have sizes, locations, and depths according to preferences corresponding thereto.

As illustrated in FIG. 5B, a pointing GUI 10 may be displayed to be disposed on the cubic GUI 511 representing content-related information having high priority. Here, the pointing GUI 10 functions to select a cubic GUI according to a user command, and may be provided in a highlight pointer form as illustrated. However, the type of the pointing GUI is merely exemplary, and the pointing GUI may be modified in various forms such as an arrow-shaped pointer or a hand-shaped pointer.

The pointing GUI 10 may move according to various types of user commands. For example, the pointing GUI 10 may move to another cubic GUI according to various user commands such as a motion command in a pointing mode of the remote control apparatus 200, a motion command in a gesture mode, a voice command, a direction key operation command provided in the remote control apparatus 200, and head (or eye) tracking.

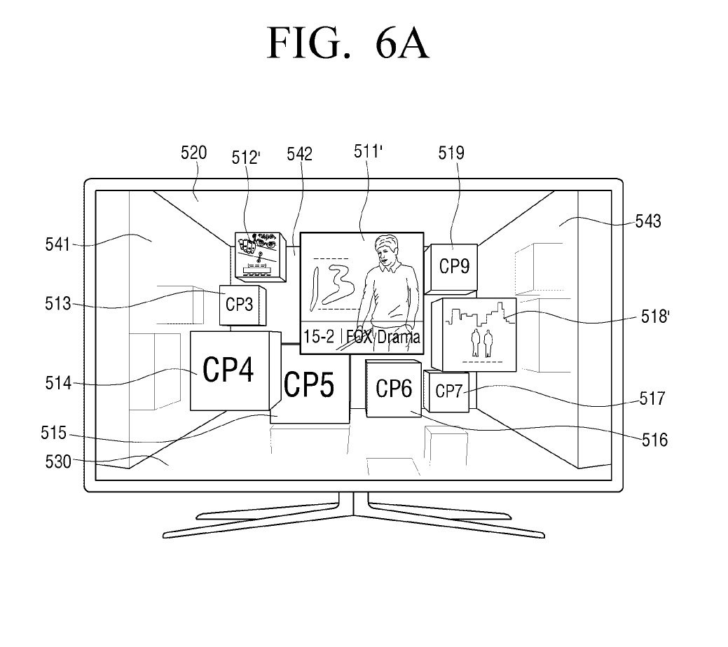

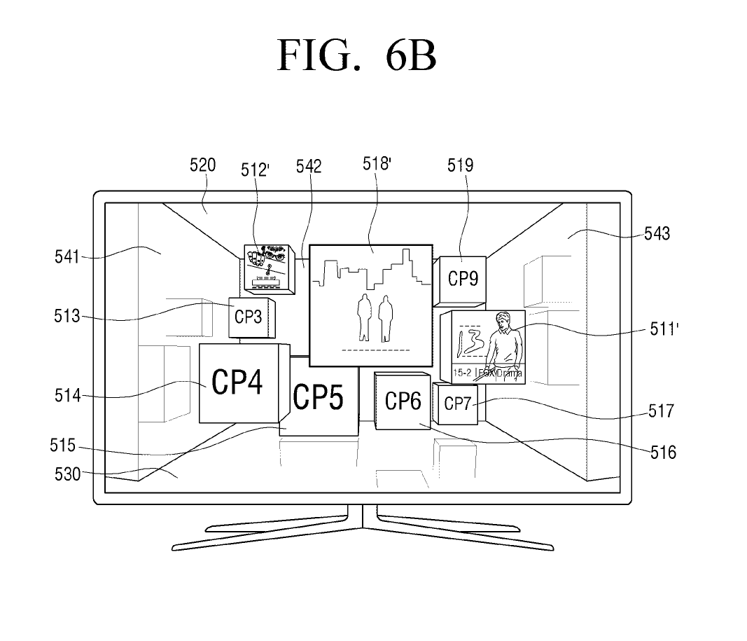

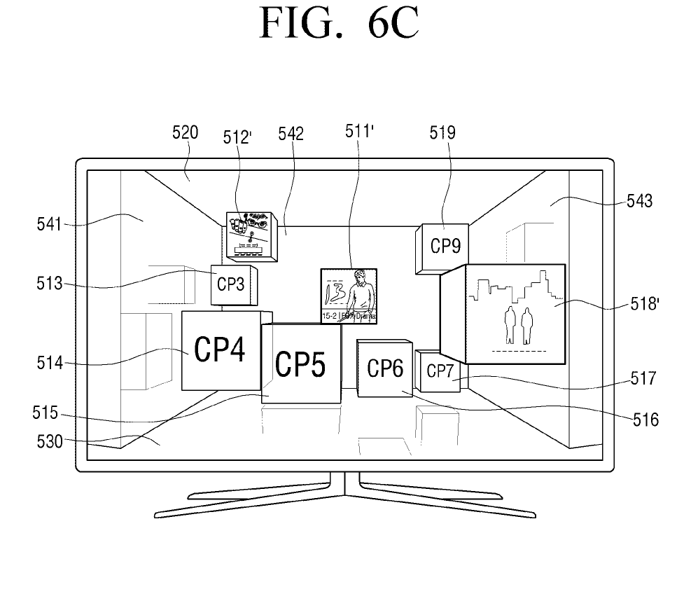

FIGS. 6A to 6C are views illustrating UI screens according to another exemplary embodiment.

As illustrated in FIG. 6A, content-related information represented by a cubic GUI may be changed according to a preset event. For example, when there are preset events for some cubic GUIs 511, 512, and 518 representing content providers in the UI screen illustrated in FIG. 5B, corresponding cubic GUIs 511′, 512′, and 518′ may represent content information provided by corresponding content providers CP1, CP2, and CP8. At this time, displayed content information may also be displayed according to a preset priority. For example, the latest updated content information may be first displayed, or content information recently reproduced by the user may be first displayed.

When cubic GUIs represent specific content information according to a user command, sizes and arrangement states of the cubic GUIs may be changed according to a priority of the cubic GUIs.

For example, as illustrated in FIG. 6B, when content represented by the cubic GUI 518′ has a higher priority than content represented by the cubic GUI 511′ (for example, when content represented by the cubic GUI 518′ is the latest updated content), locations of the cubic GUI 511′ and the cubic GUI 518′ may be changed to be displayed.

Alternatively, as illustrated in FIG. 6C, the cubic GUIs 511′ and 518′ may be displayed so that a size of the cubic GUI 511′ is reduced, and a size of the cubic GUI 518′ is increased. However, the display of the cubic GUIs is merely exemplary, and the cubic GUIs may be modified and displayed in various forms to reflect priorities of content represented by cubic GUIs. That is, although not shown in FIG. 6C, only depths of the cubic GUIs may be changed at a state in which the sizes and locations of the cubic GUI 511′ and the cubic GUI 518′ are maintained.

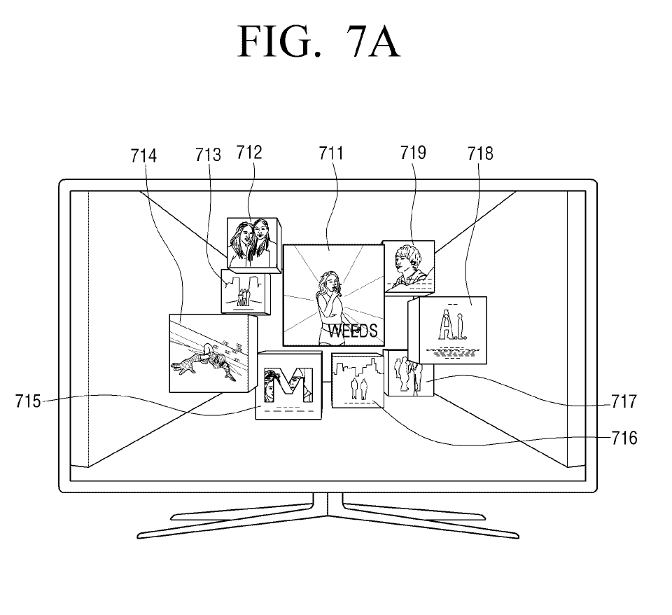

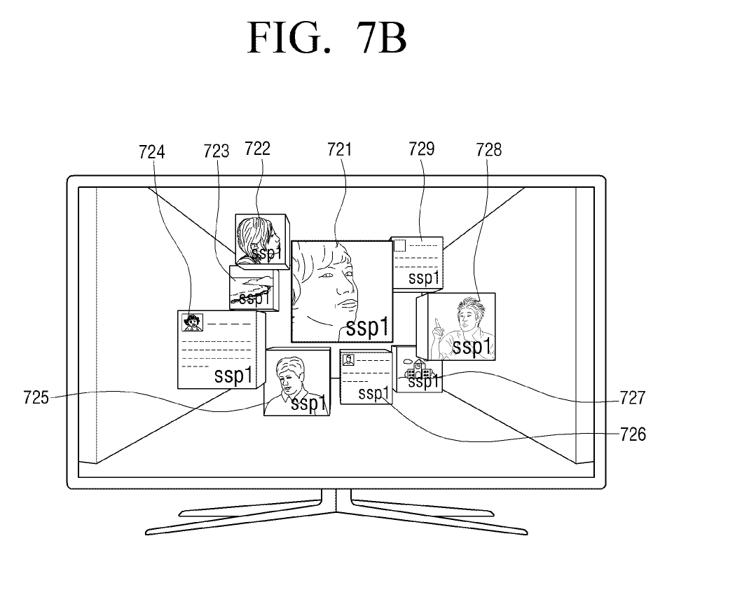

FIGS. 7A and 7B are views illustrating UI screens according to an exemplary embodiment.

As illustrated in FIG. 7A, cubic GUIs may represent a plurality of pieces of content information provided by a specific content provider. For example, when the cubic GUI 511 representing a specific content provider is selected in the UI screen illustrated in FIG. 5B, sub-cubic GUIs 711 to 719 of the cubic GUI 511 may be displayed to represent a plurality of pieces of content information provided by a content provider CP1. The sub-cubic GUIs may be displayed so that sizes and arrangement states of the sub-cubic GUIs are different. For example, when the update time is a criterion, a sub-cubic GUI 711 representing the latest updated content is displayed in a central portion of a screen to have the largest size and the smallest depth, and a sub-cubic GUI 717 representing the first updated content may be displayed in an edge portion of the screen to have the smallest size and the largest depth. However, the display of the cubic GUI is merely exemplary, and various types of criteria such as a preferential genre of the user, and a consumption time of the user may be used to determine the priority.

As illustrated in FIG. 7B, a plurality of cubic GUIs may represent a variety of information according to a category represented by a cubic room. For example, when a cubic room corresponding to an SNS content sharing-based category is displayed as illustrated in FIG. 7B, a plurality of cubic GUIs 721 to 729 may represent a plurality of social users registered in a specific SNS service SSP 1. However, this is merely exemplary, and the plurality of cubic GUIs 721 to 729 may represent a plurality of SNS service providers (SSPs), for example, Facebook, KakaoTalk, and the like, or may represent a plurality of pieces of content published by a specific social user, depending on and arrayed along an X-axis of a screen, and may have a preset depth in a Z-axis. The plurality of cubic GUIs may be displayed in different sizes and arrangement states according to priorities of social users represented in the cubic GUIs. For example, when a degree of social activity is a criterion, the cubic GUI 721 representing the most active user is displayed in a central portion of a screen to have the largest size and the smallest depth, and the cubic GUI 727 representing the most inactive user may be displayed to have the smallest size and the largest depth. The degree of social activity may be determined by various activities to be included in the social activity, such as content upload and writing of comments. However, the social activity is merely exemplary, and the various types of criteria such as a degree of familiarity of the user with the display apparatus 100 may be used to determine the priority.

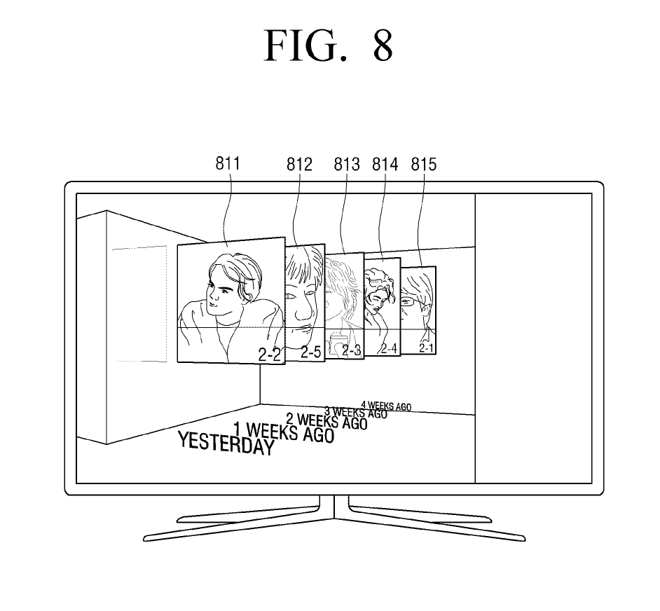

FIG. 8 is a view illustrating a UI screen according to another exemplary embodiment.

When the cubic GUI 511′ representing specific content is selected according to a user command in the UI screen illustrated in FIG. 6A, at least one among detailed information, associated information, and recommended information of content represented in the selected cubic GUI 511′ may be displayed in a plurality of panel GUIs generated when the selected cubic GUI 511′ is sliced. For example, as illustrated in FIG. 8, when the cubic GUI 511 represents series content, a series of content or a series content group may be displayed in panel GUIs 811 to 815. The plurality of panel GUIs may be displayed in a form in which the plurality of panel GUIs are sequentially arrayed with respect to an X-axis of a screen but the plurality of panel GUIs have different Z-axis depths, as illustrated in FIG. 8.

Specifically, the plurality of panel GUIs may be sequentially arrayed on the basis of sub content represented in the plurality of panel GUIs, that is, an update time of the series content. However, the array of the cubic GUIs is merely exemplary, and the plurality of panel GUIs may be sequentially arrayed according to various attributes of the sub content represented therein. For example, the sub content may be sequentially arrayed according to a generation time of sub content, a degree of association, a preference of the user, etc.

Although not shown in FIG. 8, when the cubic GUI 511′ is sliced, and modified to the plurality of panel GUIs 811 to 815, various animation effects may be provided. For example, a process of slicing the cubic GUI 511′ and a process of sequentially arraying the panel GUIs may be displayed as an animation image.

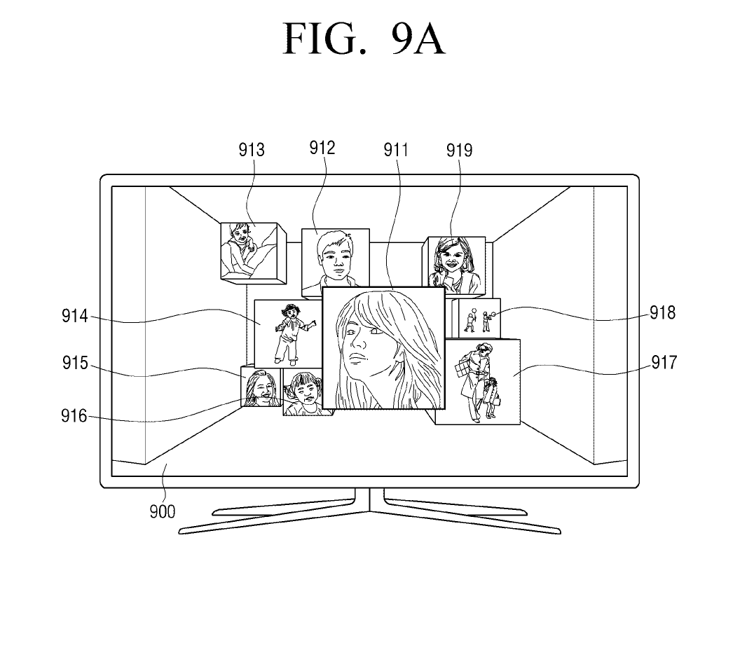

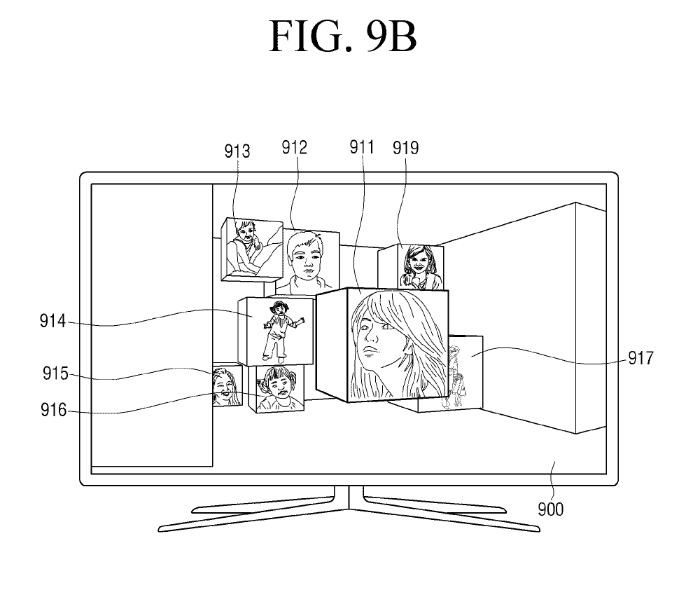

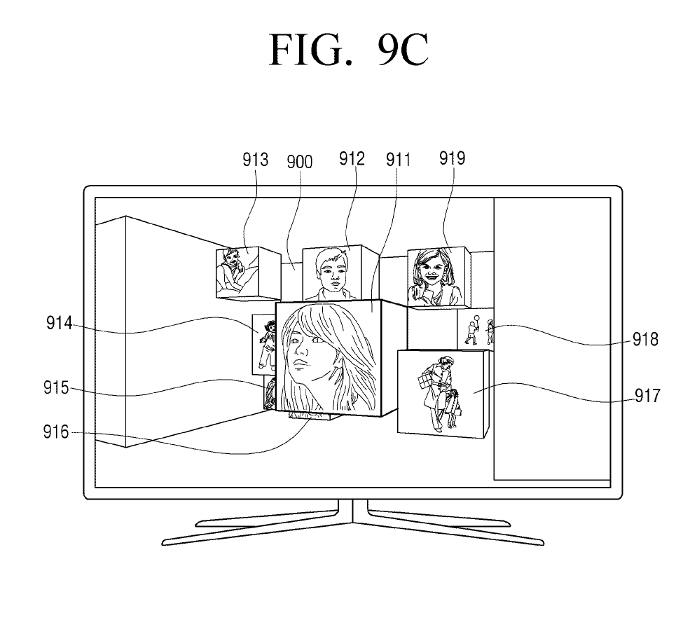

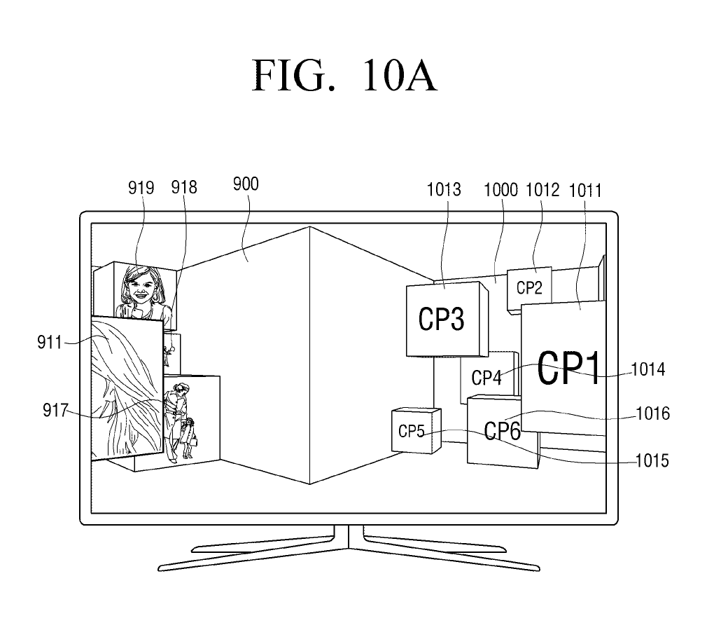

FIGS. 9A to 9C illustrate UI screens according to another exemplary embodiment.

FIGS. 9A to 9C illustrate that a cubic room and cubic GUIs included in the cubic room may be displayed in various angles.

As illustrated in FIG. 9A, a cubic room 900 and cubic GUIs 911 to 919 included in the cubic room 900 are basically displayed on the front face of the screen. That is, the front display may be performed when first entering a corresponding UI screen. At this time, sides of portions of the cubic GUIs 911 to 919 may be displayed so that the cubic GUIs are three-dimensionally displayed, but the cubic GUIs 911 to 919 may be basically displayed in a form in which the cubic GUIs 911 to 919 face forward.

As illustrated in FIG. 9B, a cubic room 900 and cubic GUIs 911 to 919 included in the cubic room 900 are displayed in a form in which left sides of the cubic GUIs 911 to 919 are viewed in a larger area than a preset area according to a preset event. For example, as illustrated in FIG. 9B, the cubic GUIs 911 to 919 may be displayed in a form shown to the user when peeking into the cubic room 900 on the left of the cubic room 900. As illustrated in FIG. 9B, the cubic GUIs 911 to 919 may be displayed in a form in which partial areas of portions of the cubic GUIs 917 and 919 on the right are covered with other cubic GUIs. The preset event may be various user commands corresponding to a peeking function. For example, the various types of user commands may include a specific motion command (for example, movement or rotation of a head (or eye)), a motion command (pointing or rotation) of a remote controller, a key operation of a remote controller, a voice command, and the like.

As illustrated in FIG. 9C, a cubic room 900 and cubic GUIs 911 to 919 included in the cubic room 900 are displayed in a form in which right sides of the cubic GUIs 911 to 919 are viewed in a larger area than a preset area according to a preset event. The display method is similar to that of FIG. 9B, and thus a detailed description thereof will be omitted.

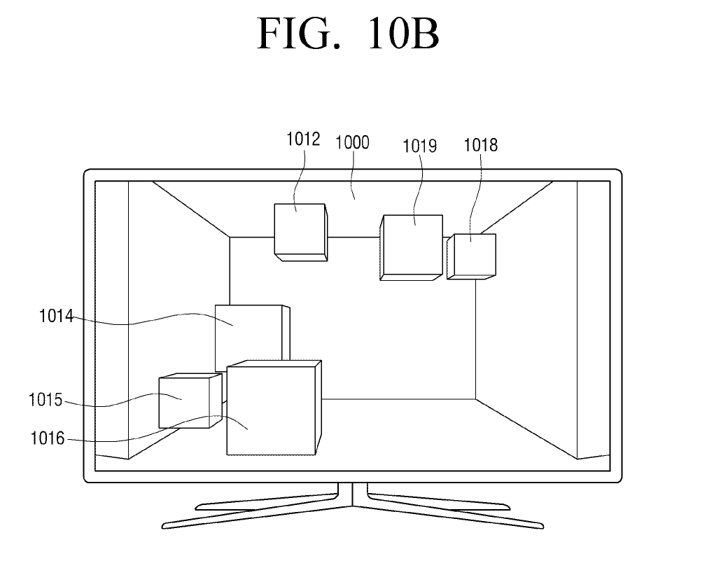

FIGS. 10A and 10B are views illustrating UI screens according to another exemplary embodiment.

FIGS. 10A and 10B illustrate various UI screens displayed in a cubic room conversion process.

As illustrated in FIG. 10A, a plurality of cubic rooms 900 and 1000 and cubic GUIs included in each of the cubic rooms may be simultaneously displayed in one screen according to a preset event. For example, while a roulette wheel is rotated according to a user command for conversion into the cubic room 1000 disposed on the left of the cubic room 900, a UI screen as illustrated in FIG. 10A may be displayed. The user may check the plurality of cubic GUIs, which are included in the plurality of cubic rooms 900 and 1000 corresponding to different categories on one screen.

When the displayed cubic room 900 is converted into another cubic room 1000, the plurality of cubic GUIs may be sequentially displayed singly and in pairs while the cubic room 1000 is displayed. Further, the cubic GUIs which are first transparently or blurredly displayed may be gradually sharpened, and finally opaquely displayed. FIG. 10B illustrates a state in which some cubic GUIs 1012, 1014, 1015, 1016, 1018, and 1019 are displayed to have a preset transparency.

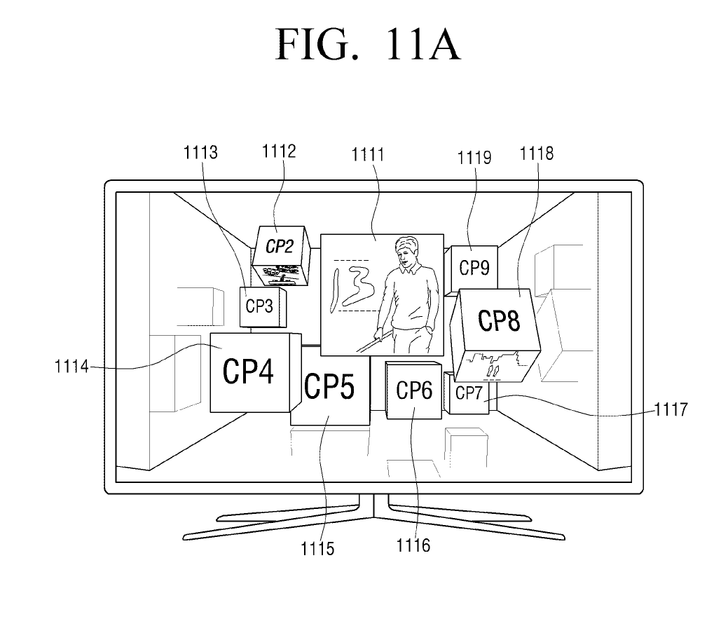

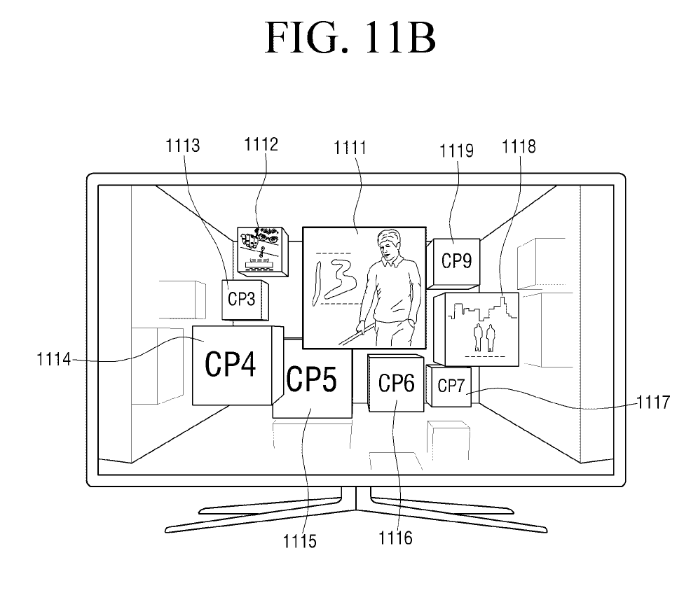

FIGS. 11A and 11B are views illustrating UI screens according to another exemplary embodiment.

As illustrated in FIG. 11A, at least one cubic GUI among displayed cubic GUIs 1111 to 1119 may be rotated and displayed according to a preset event. FIG. 11A illustrates that the cubic GUIs 1111 to 1119 are displayed in a form in which two cubic GUIs 1112 and 1118 are simultaneously rotated, but three or more cubic GUIs may be rotated simultaneously or sequentially or only one cubic GUI may be rotated. For example, the cubic GUI 1118, which provides related content or similar content, may be simultaneously rotated according to a user interaction for rotating one cubic GUI 1112. Alternatively, content related or similar to content provided from the cubic GUI 1111 already rotated may be simultaneously or sequentially rotated later. In some cases, rotation interactions for the cubic GUIs may be simultaneously generated. In some cases, the cubic GUIs may be automatically rotated based on a priority by lapse of a preset time. In addition, the event for rotation in the cubic GUIs is various, and thus the event for rotation is not limited to the above-described exemplary embodiment. FIG. 11B illustrates that rotation of some cubic GUIs are completed.

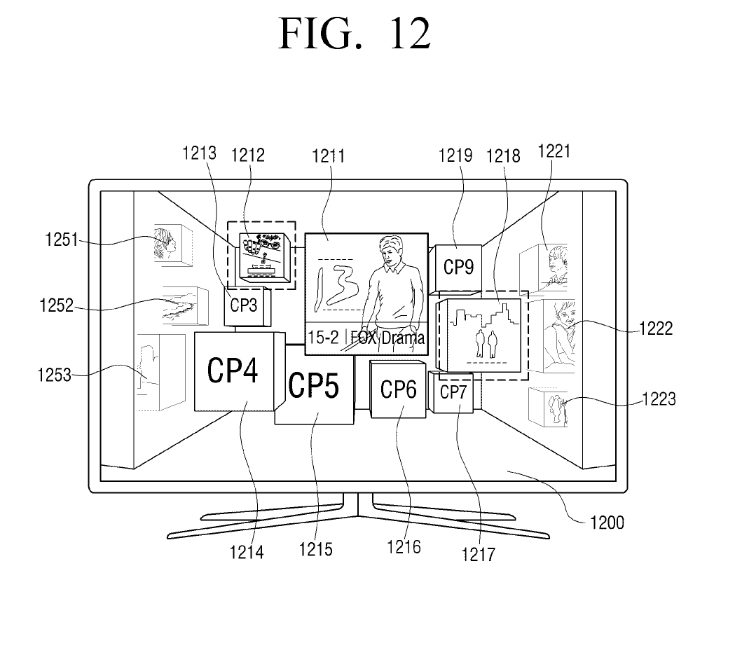

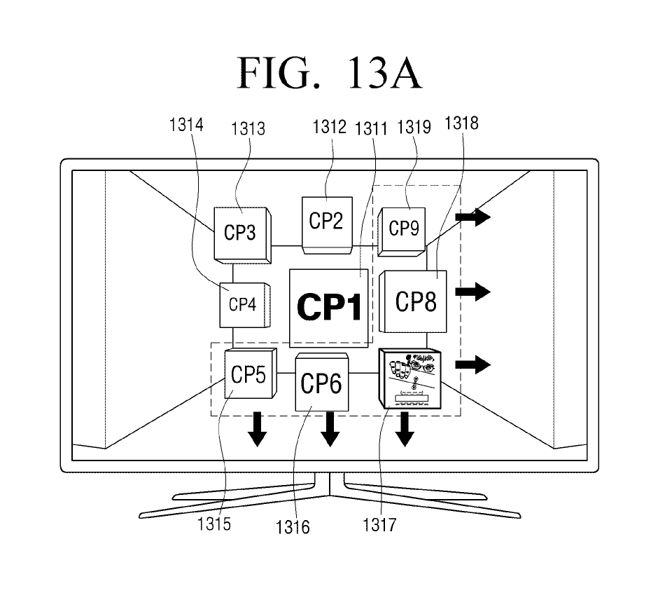

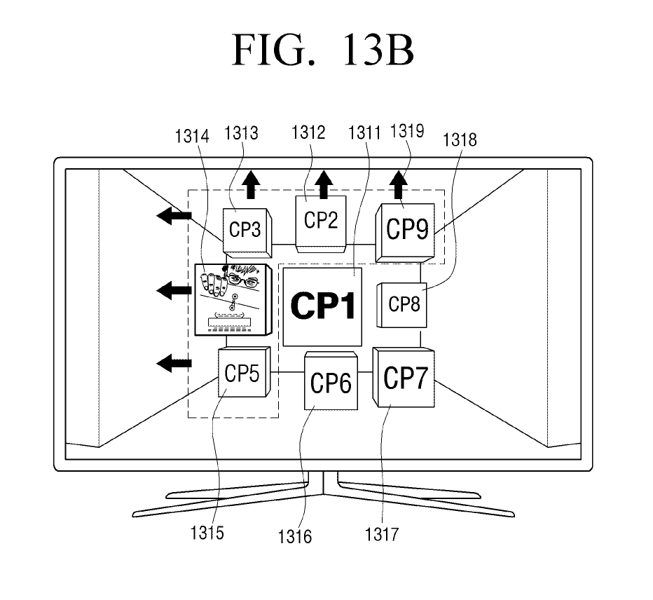

FIGS. 12, 13A and 13B are views illustrating UI screens according to another exemplary embodiment.

FIG. 12 illustrates that a cubic room 1200 belonging to a specific category and cubic GUIs 1211 to 1219 on a first cubic list included in the cubic room 1200 are displayed. Cubic GUIs 1221 to 1223 included in a second cubic list may be displayed on the left wall constituting the cubic room 1200 in a form in which the cubic GUIs have a preset transparency, that is, are transparently displayed. That is, cubic GUI to be displayed next on a wall constituting a cubic room 1200 may be guided in a preview format. At this time, the cubic GUIs included in the cubic list and disposed in a corresponding direction may be displayed on the left wall in a form in which the cubic GUIs are transparently displayed. For example, when first to fifth cubic lists are included in the cubic room 1200, cubic GUIs 1251 to 1253 included in the fifth cubic list may be displayed on the left wall in a form in which the cubic GUIs are transparently displayed. At this time, another cubic list may be displayed on a wall according to a user interaction for the wall. For example, the third cubic list may be displayed on the left wall when there is a preset user interaction in a state in which the left wall is pointed to.

FIGS. 13A and 13B are views illustrating a case in which conversion to a previous cubic list or next cubic list is performed according to a user interaction.

As illustrated in FIG. 13A, when a plurality of cubic GUIs 1311 to 1319 are disposed in a 3*3 matrix form, conversion to a next cubic list is performed when there is a preset event for cubic GUIs 1315 to 1319 disposed on the bottom and the right. As illustrated in FIG. 13B, conversion to a previous cubic list is performed when there is a preset event for cubic GUIs 1312 to 1315, and 1318 disposed on the top and the left. For example, the previous cubic list may be displayed when there is a preset user interaction in a state in which the cubic GUI 1315 disposed on the bottom and the left is pointed to. Alternatively, pressing of an arrow button included in a remote controller in a state in which a cubic GUI is selected, performing of a dragging operation on a touch pad, or the like may correspond to an event for list conversion.

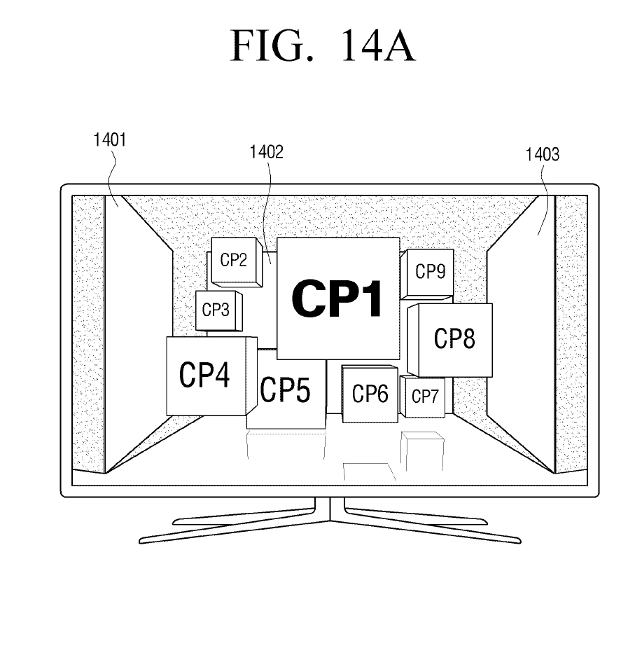

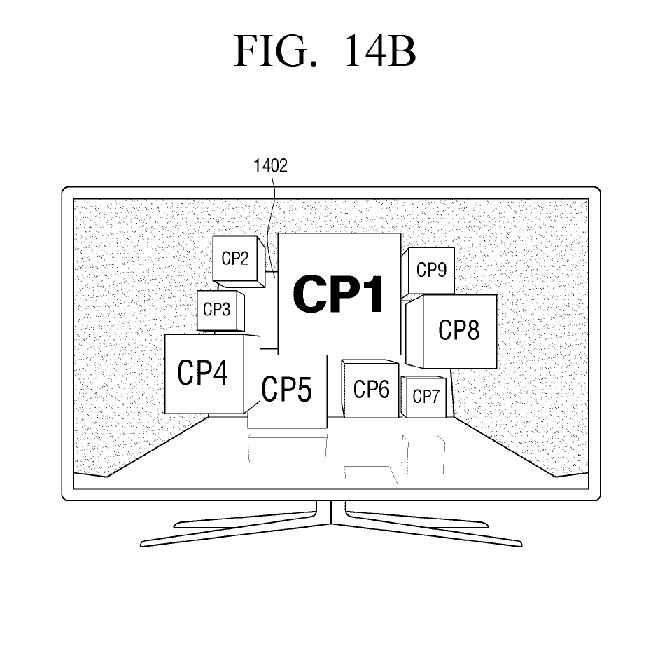

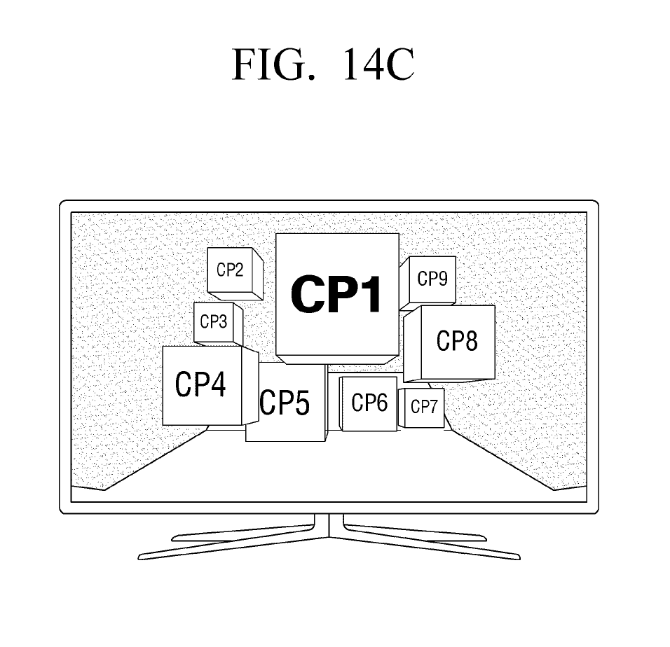

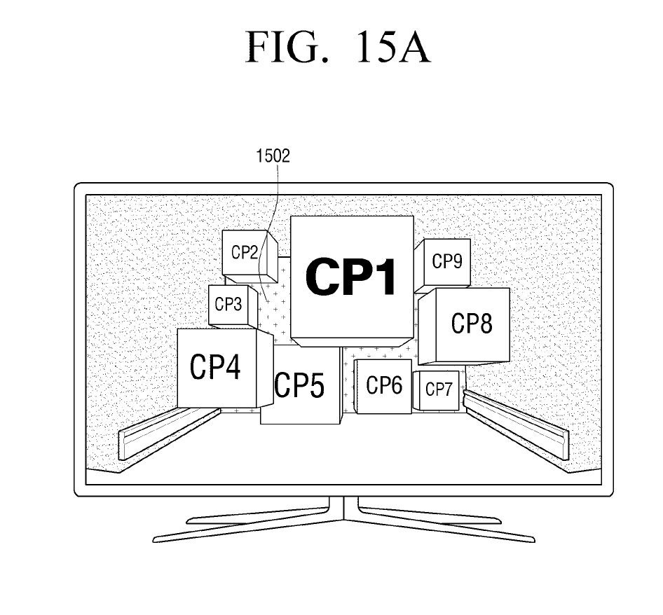

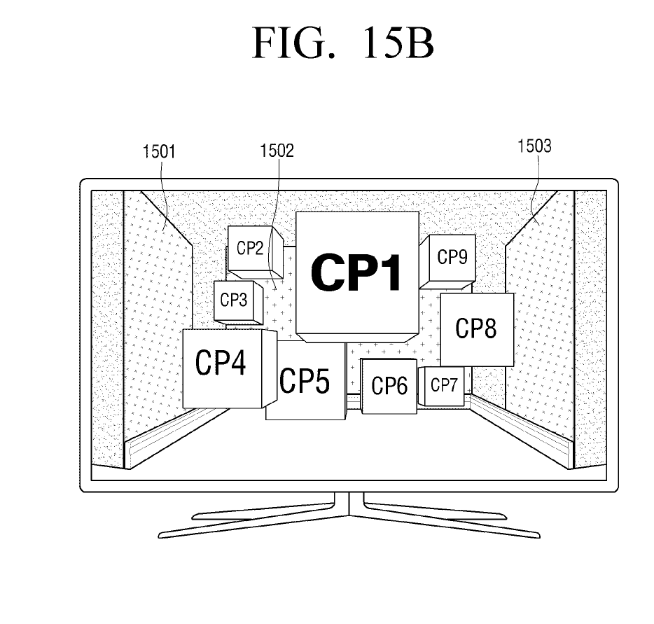

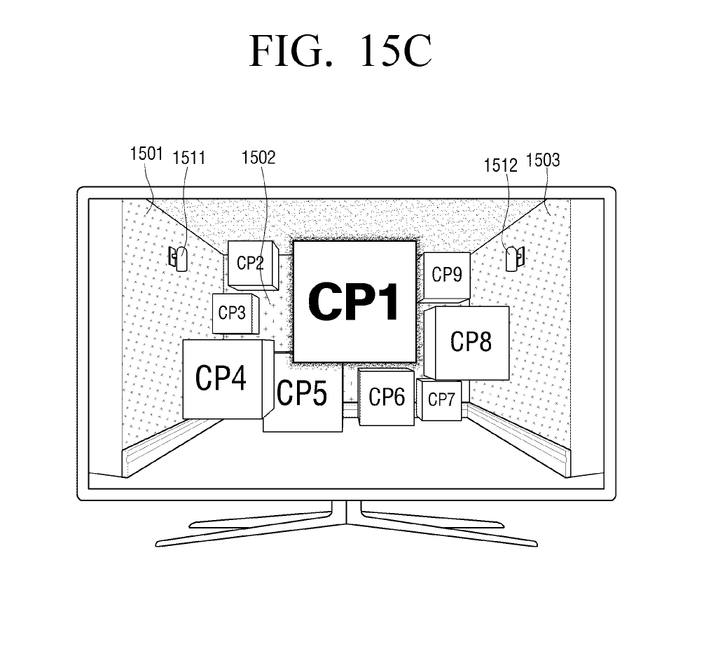

FIGS. 14A to 14C and 15A to 15C illustrate UI screens according to another exemplary embodiment.

As illustrated in FIGS. 14A to 14C and 15A to 15C, walls 1401 to 1403 constituting a cubic room may be replaced with new walls 1501 to 1503 according to a preset event.

Existing cubic rooms 1401 to 1403 constituting the cubic room as illustrated in FIGS. 14A to 14C may dynamically disappear, and the new walls 1501 to 1503 may replace the existing cubic rooms and be displayed as illustrated in FIGS. 15A to 15C. Even when the new walls 1501 to 1503 are displayed, a dynamic animation effect may be provided like when the existing walls 1401 to 1403 disappear.

As illustrated in FIG. 15C, the replaced new walls 1501 to 1503 may provide a graphic effect in a form in which a wallpaper is hung. Further, the new walls 1501 to 1503 may provide a graphic effect in which various props may be provided on the new wails 1501 to 1503. For example, light props 1511 and 1512 may be disposed on the walls 1501 and 1502 as illustrated in FIG. 15C.

However, this is merely exemplary, and displayed cubic GUIs may be displayed in a form in which the displayed cubic GUIs are reflected on the left and right walls.

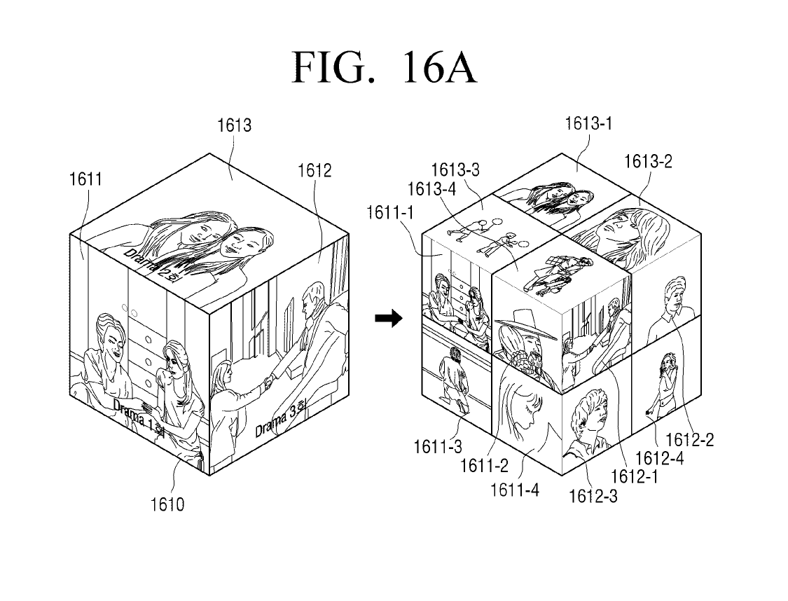

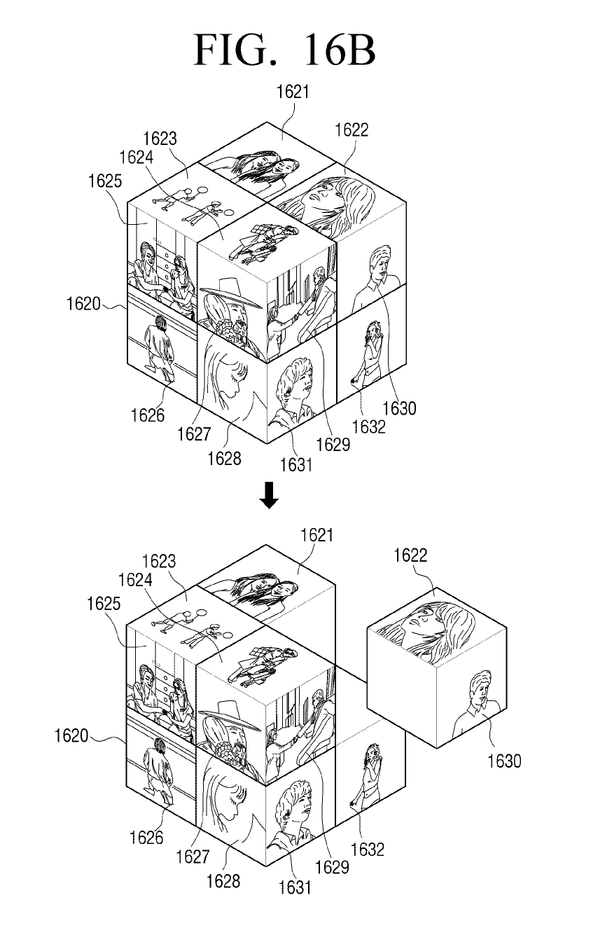

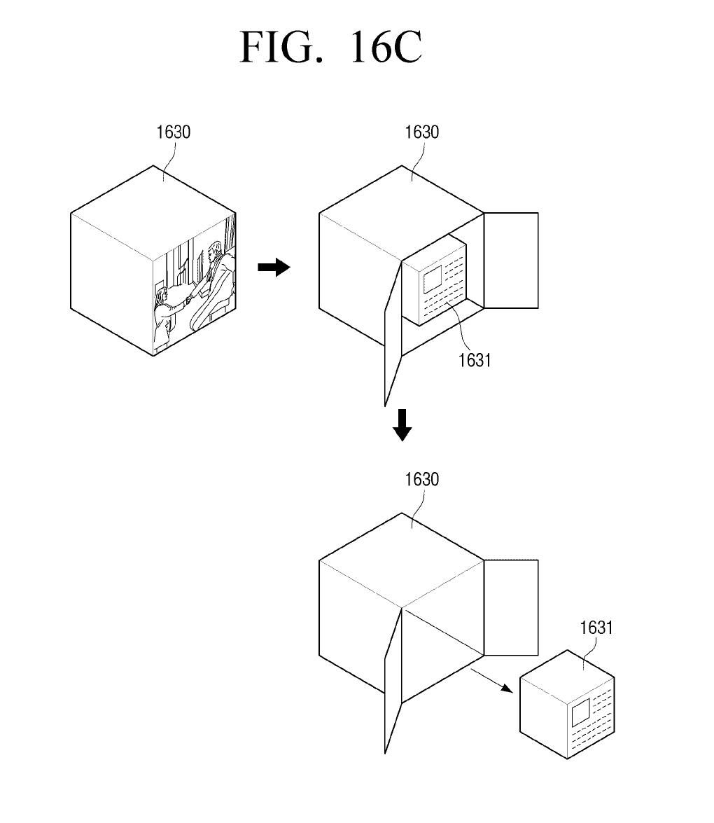

FIGS. 16A to 16C are view illustrating a cubic GUI providing method according to various exemplary embodiments.

As illustrated in FIG. 16A, surfaces 1611, 1612, and 1613 of one cubic GUI 1610 represent different information. For example, as illustrated in FIG. 16A, when at least one cubic GUI 1610 represents specific content, the surfaces 1611, 1612, and 1613 may represent a series of the content.

Further, each of the cubic surfaces 1611, 1612, and 1613 of the cubic GUI 1601 is divided according to a preset event, and a plurality of thumbnails corresponding to two or more of the series represented in the cubic surfaces may be displayed in the divided cubic surfaces of each of the cubic surfaces. However, the method is merely exemplary. In another exemplary embodiment, the cubic GUI may be displayed so that at least one of the cubic surfaces is divided and displayed, each of the cubic surfaces is divided by the large number and displayed, or hidden invisible cubic surfaces are also divided and displayed, and shown to the user according to rotation of the cubic GUI 1610.

As illustrated in FIG. 16B, a cubic GUI may be provided in a form in which a sub cubic GUI is separated from one cubic GUI.

For example, as illustrated in FIG. 16B, when specific content is selected in a state in which a main cubic GUI 1620 is divided and represents a plurality of pieces of content 1621 to 1632, a sub cubic GUI 1622 corresponding to the content is separated and provided from the main cubic GUI 1620.

As illustrated in FIG. 16C, a cubic GUI may be provided in an openable and closable form.

For example, as illustrated in FIG. 16C, in a state in which a cubic GUI 1630 represents specific content, one surface of the cubic GUI 1630 may be opened according to a user interaction, and simultaneously a sub cubic GUI 1631 representing a variety of information related to the content represented in the cubic GUI 1630 may pop out. For example, the sub cubic GUI 1631 may provide at least one of detailed information, associated information, and recommended information.

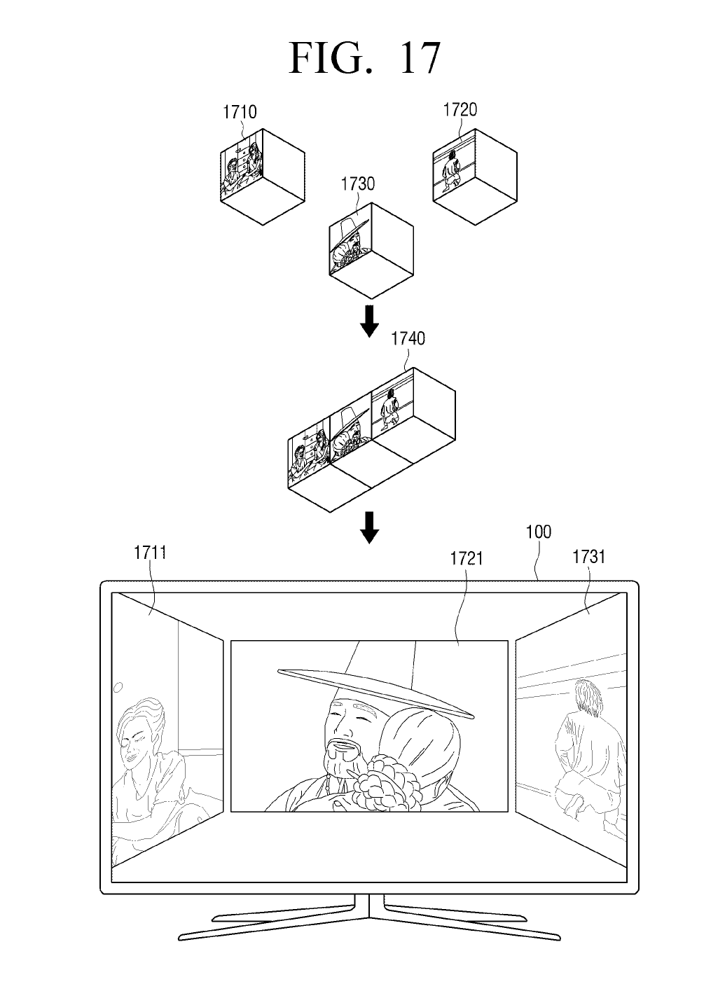

FIG. 17 is a view illustrating a UI screen according to an exemplary embodiment.

As illustrated in FIG. 17, when a plurality of cubic GUIs 1710, 1720, and 1730 representing different content are combined into one cubic GUI 1740 according to a preset event, content represented by the cubic GUIs 1710, 1720, and 1730 may be reproduced, and a plurality of screens 1711, 1721, and 1731 to which the reproduced content is provided may be displayed. For example, as illustrated in FIG. 17, the plurality of screens may include a main screen disposed in a central portion of a screen, and first and second sub screens disposed on the left and right of the screen. However, this is merely exemplary, and the plurality of screens which reproduce a plurality of pieces of content represented by the cubic GUIs 1710, 1720, and 1730 may be implemented in various forms.

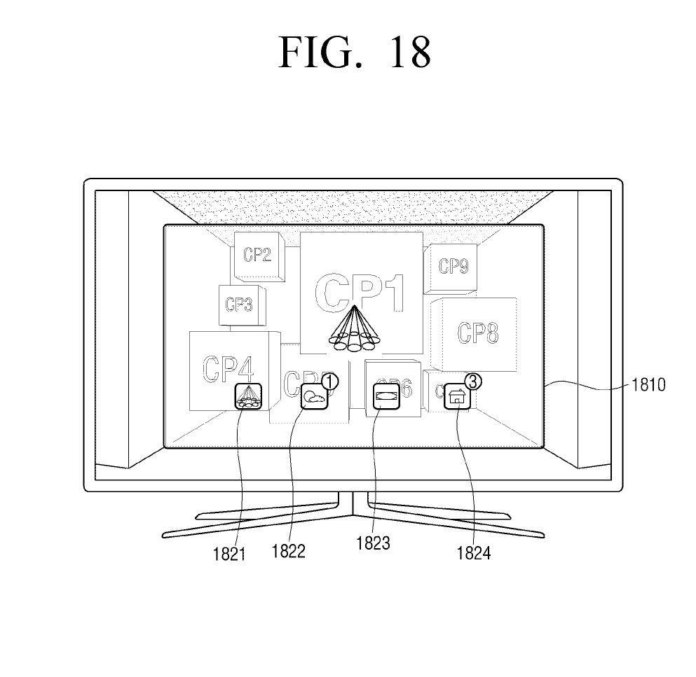

FIG. 18 is a view illustrating a UI screen according to an exemplary embodiment.

As illustrated in FIG. 18, a guide screen 1810 may be provided before the UI screen illustrated in FIG. 5A is provided. A variety of guide information 1821 to 1824 related to a provided GUI screen may be provided to the guide screen 1810. For example, a variety of service information which may be provided in the UI screen, information related to a use of the UI screen, and the like may be provided in the guide screen. As illustrated in FIG. 18, when there is update information for the service information, a mark indicating that there is updated information may be also provided.

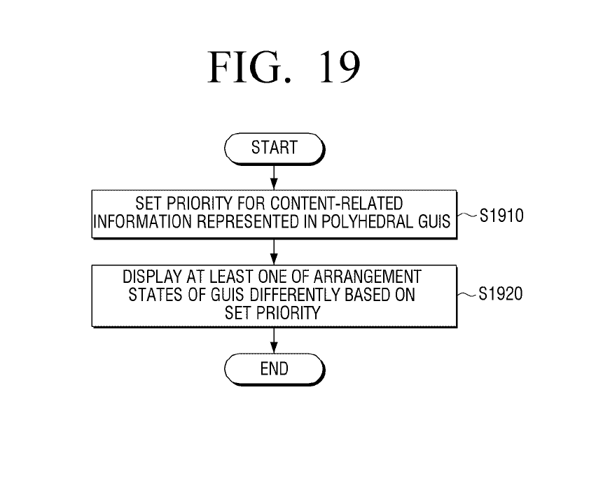

FIG. 19 is a view illustrating a UI screen providing method according to an exemplary embodiment. According to the UI screen providing method, a priority for content-related information represented in polyhedral GUIs is set (operation S1910). For example, when a cubic room corresponding to a specific category is selected in the UI screen as illustrated in FIG. 4A, the priority may be set based on at least one of a user behavior pattern and a content attribute for content included in the category. For example, an update time of the content included in the category may be determined.

Subsequently, at least one of a size and an arrangement state of the GUIs is displayed differently based on the set priority (operation S1920).

Specifically, at least one of a size and an arrangement state of cubic GUIs corresponding to content included in a category may be displayed differently based on an update time of the content. For example, content having the latest update time may be mapped with a cubic GUI having the largest size and the smallest depth and the mapped cubic GUI may be displayed in the central portion of the UI screen.

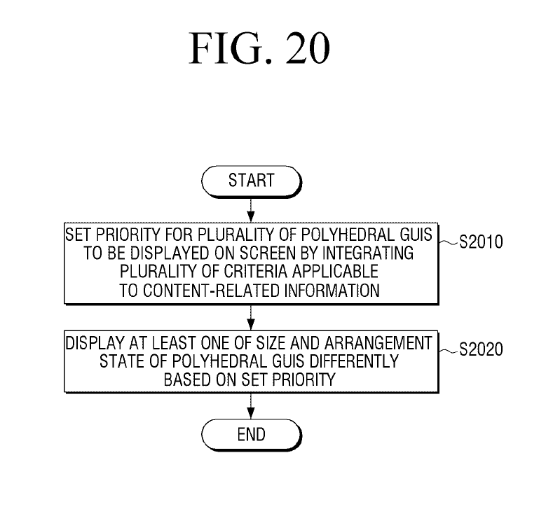

FIG. 20 is a view illustrating a UI screen providing method according to another exemplary embodiment.

According to the UI screen providing method illustrated in FIG. 20, a priority for a plurality of polyhedral GUIs to be displayed on a screen is set by integrating a plurality of criteria applicable to content-related information (operation S2010). The plurality of criteria may be at least one of a user behavior pattern and a content attribute for the content-related information.

Specifically, a cubic room corresponding to a specific category is selected, the user behavior pattern, the content attribute, and the like for a plurality of pieces of content included in the category may be integrally determined, and the priority for each of the plurality of pieces of content or each of the cubic GUIs with which the plurality of pieces of content are mapped according to a determination result may be set. For example, the priority for each of the plurality of pieces of content may be set based on an update time and a preference (for example, preferential genre) of a user for the plurality of pieces of content included in the category. At this time, the priority may be set by applying a preset weight to each of the criteria. For example, the priority may be set by applying a weight of 7/10 to the update time, applying a weight of 3/10 to the preference of the user, and integrating the criteria to which the weights are applied.

Subsequently, at least one of a size and an arrangement state of the polyhedral GUIs is displayed differently based on the set priority (operation S2020).

Specifically, the cubic GUI in which the highest priority in the example is set may be displayed to have the largest size and the smallest depth in the central portion of the screen, and the remaining cubic GUIs may be displayed to have a smaller size and a larger depth in a periphery of the screen as the priority is lowered.

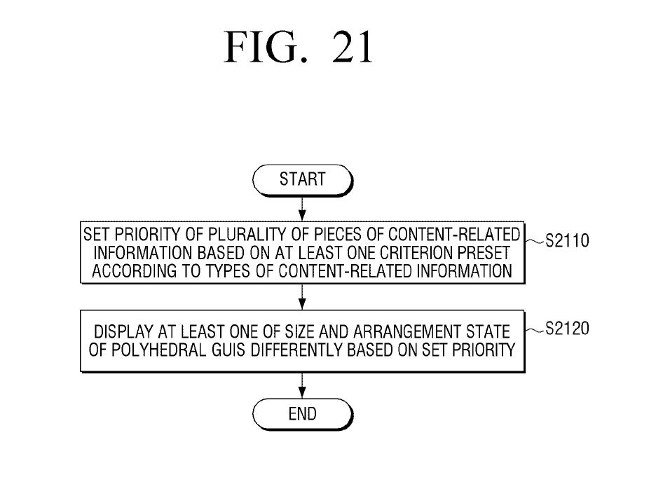

FIG. 21 is a view illustrating a UI screen providing method according to another exemplary embodiment.

According to the UI screen providing method illustrated in FIG. 21, a priority for a plurality of pieces of content-related information is set according to at least one criterion preset according to types of content-related information (operation S2110).

For example, a priority for content providers may be set according to the preference of the user, and a priority for content may be set according to the update time. At this time, when the types of content-related information represented in cubic GUIs displayed in one screen are different, a priority may be set by applying a preset weight to the criterion for determination of the priority or the types of content-related information. Further, the types of first displayed content-related information may be used as the criterion for determination of the priority.

Subsequently, at least one of a size and an arrangement state of the polyhedral GUIs is displayed differently based on the set priority (operation S2120).

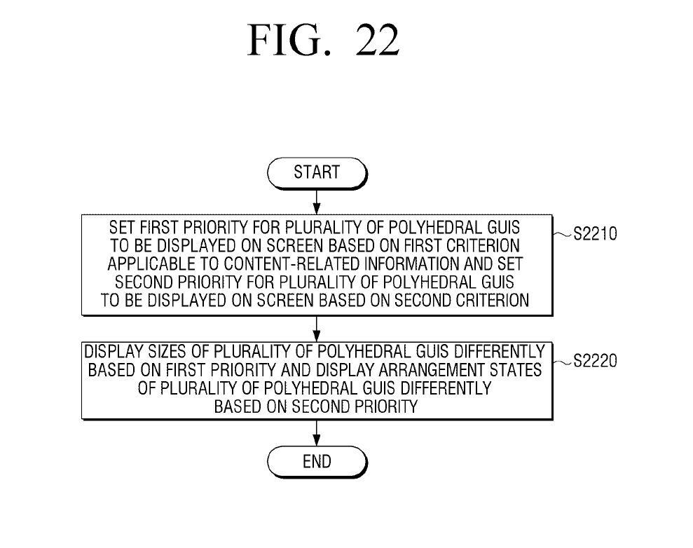

FIG. 22 is a view illustrating a UI screen providing method according to another exemplary embodiment.

According to the UI screen providing method illustrated in FIG. 22, a first priority for a plurality of polyhedral GUIs to be displayed on a screen is set based on a first criterion applicable to content-related information, and a second priority of the plurality of polyhedral GUIs to be displayed on the screen is set based on a second criterion (operation S2210). For example, the first priority of first content may be set to be higher than the priority of second content based on preferences of the user for the first content and the second content, and the second priority of the first content may be set to be lower than the priority of the second content based on update times for the first content and the second content.

Subsequently, sizes of the plurality of polyhedral GUIs are displayed differently based on the first priority, and arrangement states of the plurality of polyhedral GUIs are displayed differently based on the second priority (operation S2220). Specifically, a first cubic GUI corresponding to the first content having the high first priority in the above-described example may be displayed in a large size, and a second cubic GUI corresponding to the second content may be displayed in a small size. Further, the second cubic GUI corresponding to the second content having the high second priority may be displayed in a central portion of the screen, and the first cubic GUI may be displayed in a periphery of the screen. Therefore, the user may determine the priority according to the criteria of the cubic GUIs based on a display state.

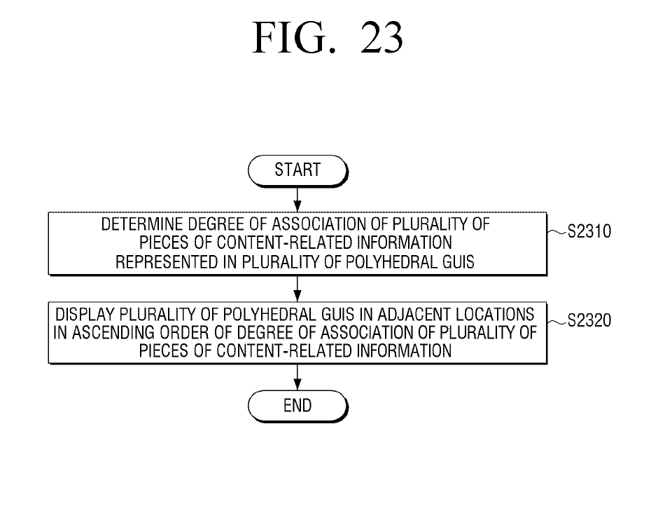

FIG. 23 is a view illustrating a UI screen providing method according to another exemplary embodiment.

According to the UI screen providing method illustrated in FIG. 23, a degree of association for a plurality of pieces of content-related information represented by a plurality of polyhedral GUIs to be displayed on a screen is determined (operation S2310). The degree of association may be determined based on various criteria according to types of the plurality of pieces of content-related information.

For example, when the plurality of polyhedral GUIs to be displayed on the screen represents movie content, the degree of association may be determined based on similarity of genres, similarity of actors, similarity of release times, and the like.

Subsequently, the plurality of polyhedral GUIs are displayed in adjacent locations in ascending order of the degree of association for the plurality of pieces of content-related information (operation S2320). In some cases, the plurality of polyhedral GUIs may be displayed with same/similar colors or contrast ratios.

According to the exemplary embodiments as described above, various functions and a variety of information may be appropriately provided according to a user interaction type to provide a user-oriented UI screen. Therefore, convenience of the user is improved.

The above-described control methods of a display apparatus according to the above-described various exemplary embodiments may be implemented with a computer-executable program code, recorded in various non-transitory computer-recordable media, and provided to servers or apparatuses to be executed by a processor. For example, the non-transitory computer-recordable medium, in which a program for performing setting a priority of content-related information displayed by a plurality of polyhedral GUIs, and generating a UI screen based on the set priority so that at least one of a size of the plurality of polyhedral GUIs and an arrangement of the plurality of polyhedral GUIs is different is stored, may be provided.

The non-transitory computer-recordable medium is not a medium configured to temporarily store data such as a register, a cache, or a memory but an apparatus-readable medium configured to semi-permanently store data. Specifically, the above-described applications or programs may be stored and provided in the non-transitory computer-recordable medium such as a compact disc (CD), a digital versatile disc (DVD), a hard disk, a Blu-ray disc, a universal serial bus (USB), a memory card, or a read only memory (ROM).

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus for displaying content-related information as a polyhedral graphical user interface (GUI), the apparatus comprising:
a display configured to display a plurality of polyhedral GUIs on a screen; and
a controller configured to control the display to display at least one of a size of the plurality of polyhedral GUIs and an arrangement of the plurality of polyhedral GUIs differently depending on a priority of the content-related information.

2. The apparatus as claimed in claim 1, wherein the controller sets the priority of the content-related information based on at least one of a pattern of a user's behavior and an attribute of the content.

3. The apparatus as claimed in claim 1, wherein the pattern of the user's behavior comprises at least one of a past usage behavior of the user, a current usage behavior of the user, and an expected usage behavior of the user, and
wherein the arrangement of the GUIs comprises at least one of a position of the GUIs on X-Y axes on the screen and a depth of the GUIs on a Z axis on the screen.

4. The apparatus as claimed in claim 1, wherein the controller is configured to control to display a pointing GUI on a GUI among the plurality of GUIs for navigating a plurality of GUIs which represent content-related information having a highest priority.

5. The apparatus as claimed in claim 1, wherein when a plurality of content-related information are associated with each other, the controller controls to display a plurality of GUIs which represent the plurality of content-related information respectively in proximity to each other.

6. The apparatus as claimed in claim 1, wherein the controller is configured to control to array and display a plurality of panel GUIs in a form where a GUI among the plurality of GUIs is sliced on a Y axis on the screen according to a predetermined event.

7. The apparatus as claimed in claim 6, wherein the plurality of panel GUIs comprise at least one of detailed information, associated information, and recommended information of the content-related information which is displayed by the GUIs.

8. The apparatus as claimed in claim 6, wherein the controller is configured to control the plurality of panel GUIs to be arrayed sequentially according to at least one of a generation time of sub information which is displayed by each of the plurality of panel GUIs, an update time of the sub information, and an association degree between the content-related information and the sub information.

9. The apparatus as claimed in claim 1, wherein the controller is configured to control to display the plurality of GUIs as floating in a three-dimensional space which is formed by a plurality of walls arrayed along an X axis and having a predetermined depth along a Z axis on the screen.

10. The apparatus as claimed in claim 9 further comprising a user interface which is configured to receive a user interaction,
wherein the controller is configured to control to convert and display a GUI list which is currently displayed in the three-dimensional space into a previous list or a next list according to the received user interaction.

11. The apparatus as claimed in claim 10, wherein when the user interaction is inputted while a pointing device is displayed on a GUI displayed on a predetermined position on the screen, the controller is configured to control to convert and display a list according to a list conversion direction which is mapped on the predetermined position.

12. The apparatus as claimed in claim 10, wherein the controller controls at least one GUI included in the previous list or the next list to be displayed with a predetermined transparency on at least one of the plurality of walls.

13. The apparatus as claimed in claim 1, wherein the content-related information comprises at least one of multimedia content information, content provider information, and service provider information.

14. A method of providing a user interface (UI) screen of a display apparatus configured to display content-related information as a polyhedral graphical user interface (GUI), the method comprising:
setting a priority of content-related information displayed by a plurality of polyhedral GUIs; and
displaying at least one of a size of the plurality of polyhedral GUIs and an arrangement of the plurality of polyhedral GUIs differently based on the set priority.

15. The method as claimed in claim 14, wherein the setting the priority comprises setting the priority of the content-related information based on at least one of a pattern of a user's behavior pattern and an attribute of the content.

16. The method as claimed in claim 15, wherein the pattern of the user's behavior comprises at least one of past usage behavior of the user, the current usage behavior of the user, and the expected usage behavior of the user, and
wherein the arrangement of the GUIs comprises at least one of a position of the GUIs on X-Y axes on the screen and a depth of the GUIs on a Z axis on the screen.

17. The method as claimed in claim 14, wherein the displaying comprises displaying a pointing GUI on a GUI among the plurality of GUIs for navigating a plurality of GUIs which represent content-related information having a highest priority.

18. The method as claimed in claim 14, wherein when a plurality of content-related information are associated with each other, the displaying comprises displaying a plurality of polyhedral GUIs which represent the plurality of content-related information respectively in proximity to each other.

19. The method as claimed in claim 14 further comprising:
displaying a plurality of panel GUIs in a form where a GUI among the plurality of GUIs is sliced on a Y axis on the screen according to a predetermined event, and
wherein the plurality of panel GUIs comprise at least one of detailed information, associated information, and recommended information of the content-related information which is displayed by the GUIs.

20. The method as claimed in claim 19, wherein the displaying the plurality of panel GUIs comprises displaying the plurality of panel GUIs to be arrayed sequentially according to at least one of a generation time of sub information which is displayed by each of the plurality of panel GUIs, an update time of the sub information, and an association degree between the content-related information and the sub information.

21. A method for displaying content-related information as a polyhedral graphical user interface (GUI), the method comprising:
providing a rotatable GUI which comprises a plurality of room-shaped three-dimensional (3D) spaces;
displaying category information corresponding to each of the plurality of room-shaped 3D spaces, and
rotating the GUI and selecting at least one of the displayed category information according to a user interaction.

22. The method of claim 21, further comprising displaying a plurality of cubic graphical GUIs when the at least one displayed category information is selected.

23. The method of claim 22, wherein the cubic graphical interfaces comprise predetermined content-related information.
